(19) United States
(12) Patent Application Publication
(10) Pub. No.: US 2016/0127903 A1
(43) Pub. Date: May 5, 2016

(54) METHODS AND SYSTEMS FOR AUTHENTICATION INTEROPERABILITY

(71) Applicant: QUALCOMM Incorporated, San Diego, CA (US)

(72) Inventors: Soo Bum Lee, San Diego, CA (US); Jouni Malinen, Tuusula (FI); George Cherian, San Diego, CA (US); Abhishek Pramod Patil, San Diego, CA (US); Santosh Paul Abraham, San Diego, CA (US)

(21) Appl. No.: 14/931,574

(22) Filed: Nov. 3, 2015

Related U.S. Application Data
(60) Provisional application No. 62/075,861, filed on Nov. 5, 2014.

(51) Int. Cl. H04W 12/06; H04L 9/08; H04W 12/04

(52) U.S. Cl. CPC H04W 12/06; H04W 12/04; H04L 9/0841; H04L 9/0861

(57) ABSTRACT

Systems, methods, and computer readable mediums for authenticating a device are disclosed. In some aspects, a method includes determining, using a second device, a key shared with the first device, generating, by the second device, a first pairwise master key (PMK) based on the key shared with the first device. The method may also include generating, by the second device, a second pairwise master key (PMK) for a first access point based on the first pairwise master key, and one or more properties of the first access point. The method then transmits the second pairwise master key to the first access point. The first access point may use the second pairwise master key to facilitate secure communication with the first device. For example, the first access point may encode/encrypt and/or decode/decrypt messages exchanged with the first device based on the second pairwise master key.

### CROSS REFERENCE TO RELATED APPLICATIONS

This application claims priority to U.S. Provisional Application No. 62/075,861, filed Nov. 5, 2014, and entitled “METHODS AND SYSTEMS FOR AUTHENTICATION INTEROPERABILITY.” The disclosure of this prior application is considered part of this application, and is hereby incorporated by reference in its entirety.

### BACKGROUND

1. Field

The present application relates generally to wireless communication systems and more specifically to systems, methods, and devices for authentication within wireless communication systems.

2. Background

In many telecommunication systems, communications networks are used to exchange messages among several interacting spatially-separated devices. Networks can be classified according to geographic scope, which could be, for example, a metropolitan area, a local area, or a personal area. Such networks would be designated respectively as a wide area network (WAN), metropolitan area network (MAN), local area network (LAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, SONET (Synchronous Optical Networking), Ethernet, etc.).

Wireless networks are often preferred when the network elements are mobile and thus have dynamic connectivity needs, or when the network architecture is formed in an ad hoc, rather than fixed, topology. When a mobile network element such as a wireless station (STA) moves into an area serviced by an access point (AP), the wireless station and access point may exchange messages to authentication and associate the wireless station with the access point. Until the authentication and association processes are completed, the wireless station may be unable to transmit or receive data using the access point. Thus, there is a need for improved methods and systems for establishing communication between the mobile station and a new access point.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include improved communications between access points and stations in a wireless network.

Some aspects of the disclosure provide for interoperability between at least portions of two different authentication methods. For example, in some aspects, a first authentication method may provide some benefits over a second authentication method. However, the second authentication method may be widely deployed, while the first authentication method has not yet been deployed. Additionally, deployment of the first authentication method may be delayed due to cost and other factors.

Thus, it may be advantageous to utilize much of the network infrastructure that is already deployed within a wireless network to support the second authentication method, while porting select portions of the first authentication method to the wireless network infrastructure. Such an approach may provide for deployment of the select portions of the first authentication method more rapidly than could be accomplished if all components of the first authentication method were deployed to the wireless network. Deployment of only the selected portions of the first authentication method may still improve network performance in one or more aspects. This performance improvement may be realized more quickly by utilizing the disclosed methods, systems, and computer readable medium when compared to a timeline associated with full deployment of the first authentication method.

For example, the IEEE 802.11ai (Fast Initial Link Setup or FILS) protocol is designed of course to support fast link setup. 802.11ai provides fast association to a new extended service set (ESS) and within an ESS. There are three authentication types within 802.11ai: 1) FILS shared key authentication using EAP-RP, 2) FILS shared key authentication using EAP-RP with perfect forward secrecy (PFS), and 3) FILS public key authentication.

IEEE 802.11r (Fast transition) is designed to support fast basic service set transition. 802.11r may provide fast handover within an ES/mobility domain.

In some aspects interoperability between IEEE 802.11r and 802.11ai can be achieved by establishing an IEEE 802.11r fast transition (FT) key hierarchy (for example, from the IEEE 802.11 specification section 11.6.1.7.1) as a result of 802.11ai authentication. In these aspects, the FT key hierarchy is established using a new defined key. The new defined key is derived differently depending on which authentication method is used. A pairwise master key is derived via IEEE 802.11ai authentication, regardless of the authentication type. The new defined key is derived using a pairwise master key derivation rule for fast transition key hierarchy establishment. In other words, in some aspects, the new defined key is equal to a pairwise master key in IEEE 802.11ai. For example, the new defined key may be derived using the formula Key=HMAC-Hash(SNonce∥ANonce, IKM). If necessary, the HMAC-Hash result may be truncated, for example, to 256 bits in length in some aspects.

The fast transition key derivation that follows derivation of the key generally follows that defined by the IEEE fast transition architecture, except the new key is substituted as RO-Key-Data=KDF-384 (New Key, “FT-RO”, SSIDlength∥SSID∥MDID∥ROKHlength∥ROKH-ID∥SOKH-ID). Thus, an authentication and association between an access point and a station can be accomplished based on the modified key derivation described above.

One aspect disclosed is a method of authenticating a first device. The method includes determining, by a second device, a key shared with the first wireless device, generating, by the second device, a first pairwise master key based on the key shared with the first wireless device, generating, by the second device, a second pairwise master key for a first access point based on the first pairwise master key, and transmitting, by the second device, the second pairwise master key to the first access point. In some aspects, the second pairwise master key is used for secure association or secure communication between the first access point and the first wireless device. In some aspects, the second device and the first access point are the same device. In some aspects, the method also includes determining a master session key by performing extensible authentication protocol with the first wireless device, wherein the key shared with the first wireless device is the master session key. In some aspects, the method also includes determining a reauthentication master session key by performing extensible authentication protocol reauthentication protocol with the first wireless device. In these aspects, the key shared with the first wireless device is the reauthentication master session key. In some aspects, the method also includes determining a shared secret by performing a diffie hellman key exchange with the first wireless device, and generating the first pairwise master key further based on the shared secret. In some aspects, the method also includes determining a shared secret by performing a diffie hellman key exchange with the first wireless device. In these aspects, the key shared with the first wireless device is the shared secret.

Some aspects of the method also include generating an intermediate key based on a nonce generated by the first wireless device, a second nonce generated by the second device, and the key shared with the first wireless device; and generating the first pairwise master key based on the intermediate key. Some aspects of the method also include generating, by the second device, a third pairwise master key for a second access point based on the first pairwise master key, the third pairwise master key for use in communication between the second access point and the first wireless device; and transmitting the third pairwise master key to the second access point.

In some aspects, the method includes receiving a shared key authentication request with perfect forward secrecy for the first wireless device from the first access point, and generating, in response to receiving the shared key authentication request, the first pairwise master key further based on a reauthentication master session key. In some aspects, the method includes concatenating the reauthentication master session key and the shared secret, wherein the generating of the first pairwise master key is based on the concatenation. In some aspects, the method includes transmitting, by the second device, an authentication request to an authentication server in response to receiving the shared key authentication request; and receiving, by the second device, the reauthentication master session key from the authentication server.

Another aspect disclosed is an apparatus for authenticating a first device. The apparatus includes a processor, configured to: determine a key shared with the first wireless device, generate a first pairwise master key based on the key shared with the first wireless device, generate a second pairwise master key for a first access point based on the first pairwise master key; and a transmitter configured to transmit the second pairwise master key to the first access point. In some aspects, the second pairwise master key is used for secure association or secure communication between the first access point and the first wireless device. In some aspects, the first access point and the apparatus are the same device.

In some aspects of the apparatus, the processor is further configured to determine a master session key by performing extensible authentication protocol with the first wireless device, wherein the key shared with the first wireless device is the master session key. In some aspects of the apparatus, the processor is further configured to determine a reauthentication master session key by performing extensible authentication protocol reauthentication protocol with the first wireless device. In these aspects, the key shared with the first wireless device is the reauthentication master session key.

In some aspects of the apparatus, the processor is further configured to determine a shared secret by performing a diffie hellman key exchange with the first wireless device, and generating the first pairwise master key further based on the shared secret. In some aspects, the processor is further configured to determine a shared secret by performing a diffie hellman key exchange with the first wireless device, wherein the key shared with the first wireless device is the shared secret. In some aspects of the apparatus, the processor is further configured to: generate an intermediate key based on a nonce generated by the first wireless device, a nonce generated by the apparatus, and the key shared with the first wireless device, and generate the first pairwise master key based on the intermediate key. In some aspects of the apparatus, the processor is further configured to: generate a third pairwise master key for a second access point based on the first pairwise master key, the third pairwise master key for use in communication between the second access point and the first wireless device, and wherein the transmitter is further configured to transmit the third pairwise master key to the second access point. Some aspects of the apparatus also include a receiver configured to receive a shared key authentication request with perfect forward secrecy for the first wireless device from the first access point. In these aspects, the processor is further configured to generate, in response to receiving the shared key authentication request, the first pairwise master key further based on a reauthentication master session key.

In some aspects of the apparatus, the processor is further configured to concatenate the reauthentication master session key and the shared secret, wherein the processor is further configured to generate the first pairwise master key based on the concatenation. In some aspects, the transmitter is further configured to transmit an authentication request to an authentication server in response to receiving the shared key authentication request. In these aspects, the receiver is further configured to receive the reauthentication master session key from the authentication server.

Another aspect disclosed is an apparatus for authenticating a first device. The apparatus includes means for determining a key shared with the first wireless device, means for generating a first pairwise master key based on the key shared with the first wireless device, means for generating a second pairwise master key for a first access point based on the first pairwise master key and means for transmitting the second pairwise master key to the first access point.

In some aspects, the apparatus includes means for determining a master session key by performing extensible authentication protocol with the first device, wherein the key shared with the first device is the master session key. In some aspects, the apparatus includes determining a reauthentication master session key by performing extensible authentication protocol reauthentication protocol with the first device, wherein the key shared with the first wireess device is the reauthentication master session key.

In some aspects, the apparatus includes means for determining a shared secret by performing a diffie hellman key exchange with the first device, and means for generating the first pairwise master key further based on the shared secret. In some aspects, the apparatus also includes means for determining a shared secret by performing a diffie hellman key exchange with the first device, wherein the key shared with the first device is the shared secret. In some aspects, the apparatus also includes means for generating an intermediate key based on a nonce generated by the first device, a nonce generated by the apparatus, and the key shared with the first device; and means for generating the first pairwise master key based on the intermediate key.

Some aspects of the apparatus also include means for generating a third pairwise master key for a second access point based on the first pairwise master key, the third pairwise master key for use in communication between the second access point and the first device, and means for transmitting the third pairwise master key to the second access point.

Some aspects of the apparatus also include means for receiving a shared key authentication request with perfect forward secrecy for the first device from the first access point; and means for generating, in response to receiving the shared key authentication request, the first pairwise master key further based on a reauthentication master session key.

Some aspects of the apparatus also include means for concatenating the reauthentication master session key and the shared secret, wherein the generating of the first pairwise master key is based on the concatenation. In some of these aspects, the apparatus includes means for transmitting an authentication request to an authentication server in response to receiving the shared key authentication request; and means for receiving the reauthentication master session key reauthentication master session key from the authentication server.

Another aspect disclosed is a computer readable storage medium comprising instructions that when executed cause a processor to perform a method of authenticating a first wireless device. The method includes determining, by a second device, a key shared with the first wireless device, generating, by the second device, a first pairwise master key based on the key shared with the first wireless device, generating, by the second device, a second pairwise master key for a first access point based on the first pairwise master key, and transmitting, by the second device, the second pairwise master key to the first access point. In some aspects, the second pairwise master key is used for secure association or secure communication between the first access point and the first wireless device. In some aspects, the second device and the first access point are the same device. In some aspects, the method also includes determining a master session key by performing extensible authentication protocol with the first wireless device, wherein the key shared with the first wireless device is the master session key. some aspects, the method also includes determining a reauthentication master session key by performing extensible authentication protocol reauthentication protocol with the first wireless device. In these aspects, the key shared with the first wireless device is the reauthentication master session key. In some aspects, the method also includes determining a shared secret by performing a diffie hellman key exchange with the first wireless device, and generating the first pairwise master key further based on the shared secret. In some aspects, the method also includes determining a shared secret by performing a diffie hellman key exchange with the first wireless device. In these aspects, the key shared with the first wireless device is the shared secret.

Some aspects of the computer readable storage medium comprise instructions that cause a processor to further perform the method also including generating an intermediate key based on a nonce generated by the first wireless device, a second nonce generated by the second device, and the key shared with the first wireless device; and generating the first pairwise master key based on the intermediate key. Some aspects of the method also include generating, by the second device, a third pairwise master key for a second access point based on the first pairwise master key, the third pairwise master key for use in communication between the second access point and the first wireless device; and transmitting the third pairwise master key to the second access point.

In some aspects, the CRM method includes receiving a shared key authentication request with perfect forward secrecy for the first wireless device from the first access point, and generating, in response to receiving the shared key authentication request, the first pairwise master key further based on a reauthentication master session key. In some aspects, the method includes concatenating the reauthentication master session key and the shared secret, wherein the generating of the first pairwise master key is based on the concatenation. In some aspects, the method includes transmitting, by the second device, an authentication request to an authentication server in response to receiving the shared key authentication request; and receiving, by the second device, the reauthentication master session key from the authentication server.

Another aspect disclosed is a method of authenticating a first device. The method includes determining, by a first device, a key shared with a second device, generating, by the first device, a first pairwise master key based on the key shared with the second device, generating, by the first device, a second pairwise master key for communication with the second device; and communicating with the second device based on the second pairwise master key.

In some aspects, the method also includes determining a master session key by performing extensible authentication protocol with the second device, wherein the key shared with the second device is the master session key. In some aspects, the method includes determining a reauthentication master session key by performing extensible authentication protocol reauthentication protocol with the second device, wherein the key shared with the second device is the reauthentication master session key. In some aspects, the method includes concatenating the reauthentication master session key and the shared secret, wherein the generating of the first pairwise master key is based on the concatenation. In some aspects, the method also includes determining a shared secret by performing a diffie hellman key exchange with the second device, and generating the first pairwise master key further based on the shared secret. In some aspects, the method also includes determining a shared secret by performing a diffie hellman key exchange with the second device, wherein the key shared with the first device is the shared secret. In some aspects, the method also includes generating an intermediate key based on a nonce generated by the first device, a second nonce generated by the second device, and the key shared with the second device; and generating the first pairwise master key based on the intermediate key. In some aspects, the method also includes generating, by the first device, a third pairwise master key for a third device based on the first pairwise master key; and communicating with the third device based on the third pairwise master key.

Another aspect disclosed is an apparatus for authenticating a first device. The apparatus includes a processor configured to determine a key shared with a second device, generate a first pairwise master key based on the key shared with the second device, generate a second pairwise master key for communication with the second device; and communicate with the second device based on the second pairwise master key. In some aspects of the apparatus, the processor is further configured to determine a master session key by performing extensible authentication protocol with the second device, wherein the key shared with the second device is the master session key. In some aspects of the apparatus, the processor is further configured to determine a reauthentication master session key by performing extensible authentication protocol reauthentication protocol with the second device, wherein the key shared with the second device is the reauthentication master session key.

In some aspects of the apparatus, the processor is further configured to concatenate the reauthentication master session key and the shared secret, wherein the generating of the first pairwise master key is based on the concatenation. In some aspects of the apparatus, the processor is further configured to determine a shared secret by performing a diffie hellman key exchange with the second device, and generating the first pairwise master key further based on the shared secret. In some aspects, the processor is further configured to determine a shared secret by performing a diffie hellman key exchange with the second device, wherein the key shared with the first device is the shared secret. In some aspects, the processor is further configured to generate an intermediate key based on a nonce generated by the first device, a second nonce generated by the second device, and the key shared with the second device; and generate the first pairwise master key based on the intermediate key. In some aspects, the processor is further configured to generate a third pairwise master key for a third device based on the first pairwise master key and one or more properties of the third device; and communicate with the third device based on the third pairwise master key.

### BRIEF DESCRIPTION OF THE DRAWINGS

FIG. 1 shows an exemplary wireless communication system in which aspects of the present disclosure can be employed.

FIG. 2 illustrates a illustrative embodiment of a wireless device of one or more of the mobile devices of FIG. 1.

FIG. 3 illustrates message flows during an extended authentication protocol (EAP) authentication and an extended authentication protocol reauthentication protocol (EAP-RP) authentication.

FIG. 4 illustrates message flows during a fast basic service set (BSS) transition (FT) authentication.

FIG. 5 illustrates message flows between wireless network components during one embodiment of an authentication process.

FIG. 6 illustrates message flows between wireless network components in another embodiment of an authentication process.

FIG. 7 illustrates message flows between wireless network components in another embodiment of an authentication process.

FIG. 8 illustrates message flows between wireless network components in another embodiment of an authentication process.

FIG. 9 illustrates message flows between wireless network components in another embodiment of an authentication process when no local ER server is present.

FIG. 10 is a message sequence diagram showing use of authentication message from a first authentication protocol and a second authentication protocol.

FIG. 11 shows a key hierarchy in an authentication method

FIG. 12 is a flowchart of a method of authenticating a device.

FIG. 13 illustrates message flows between wireless network components in another embodiment of an authentication process.

FIG. 14 illustrates message flows between wireless network components in another embodiment of an authentication process.

FIG. 15 is a flowchart of a method of authenticating a device.

FIG. 16 is a flowchart of a method of authenticating a device.

FIG. 17 is a flowchart of a method of authenticating a device.

### DETAILED DESCRIPTION

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

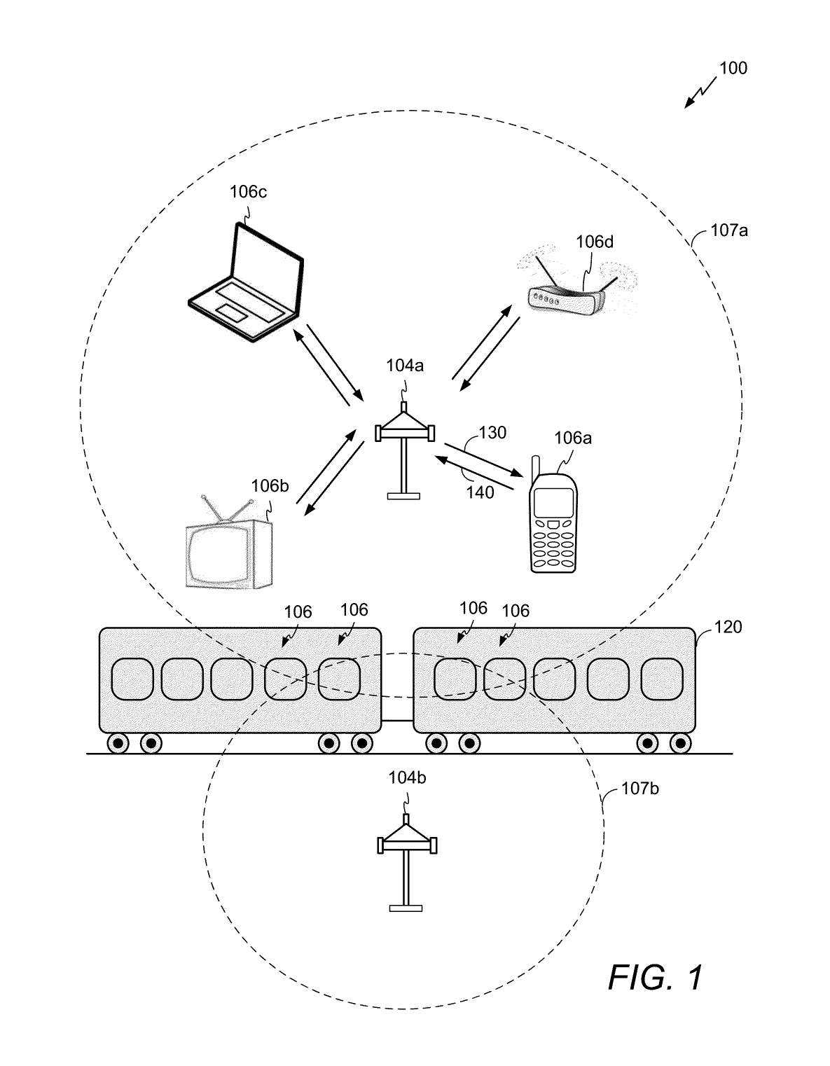

FIG. 1 shows an exemplary wireless communication system 100 in which aspects of the present disclosure can be employed. The wireless communication system 100 includes an access point (AP) 104a, which communicates with a plurality of stations (STAs) 106a-106d in a basic service area (BSA) 107a. The wireless communication system 100 can further include a second AP 104b which can communicate in a BSA 107b. One or more STAs 106 can move in and/or out of the BSAs 107a-107b, for example, via a train 120. In various embodiments described herein, the STAs 106 and 106a-106d can be configured to quickly establish wireless links with the AP 104a and/or 104b, particularly when moving into the BSAs 107a and/or 107b. Establishing wireless communication between a station and an access point may include one or more of authentication and association.

In various embodiments, the wireless communication system 100 can include a wireless local area network (WLAN). The WLAN can be used to interconnect nearby devices, employing one or more networking protocols. The various aspects described herein can apply to any communication standard, such as IEEE 802.11 wireless protocols. For example, the various aspects described herein can be used as part of the IEEE 802.11a, 802.11b, 802.11g, 802.11n, 802.11ah, and/or 802.11ai protocols. Implementations of the 802.11 protocols can be used for sensors, home automation, personal healthcare networks, surveillance networks, metering, smart grid networks, intra- and inter-vehicle communication, emergency coordination networks, cellular (e.g., 3G/4G) network offload, short- and/or long-range Internet access (e.g., for use with hotspots), machine-to-machine (M2M) communications, etc.

The APs 104a-104b can serve as a hub or base station for the wireless communication system 100. For example, the AP 104a can provide wireless communication coverage in the BSA 107a, and the AP 104b can provide wireless communication coverage in the BSA 107b. The AP 104a and/or 104b can include, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, or some other terminology.

The STAs 106 and 106a-106d (collectively referred to herein as STAs 106) can include a variety of devices such as, for example, laptop computers, personal digital assistants (PDAs), mobile phones, etc. The STAs 106 can connect to, or associate with, the APs 104a-104b via a WiFi (e.g., IEEE 802.11 protocol such as 802.11ai) compliant wireless link to obtain general connectivity to the Internet or to other wide area networks. The STAs 106 may also be referred to as “clients.”

In various embodiments, the STAs 106 can include, be implemented as, or be known as access terminals (ATs), subscriber stations, subscriber units, mobile stations, remote stations, remote terminals, user terminals (UTs), terminals, user agents, user devices, user equipment (UEs), or some other terminology. In some implementations, a STA 106 can include a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein can be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

The AP 104a, along with the STAs 106a-106d associated with the AP 104a, and that are configured to use the AP 104a for communication, can be referred to as a basic service set (BSS). In some embodiments, the wireless communication system 100 may not have a central AP 104a. For example, in some embodiments, the wireless communication system 100 can function as a peer-to-peer network between the STAs 106. Accordingly, the functions of the AP 104a described herein can alternatively be performed by one or more of the STAs 106. Moreover the AP 104a can implement one or more aspects described with respect to the STAs 106, in some embodiments.

A communication link that facilitates transmission from the AP 104a to one or more of the STAs 106 can be referred to as a downlink (DL) 130, and a communication link that facilitates transmission from one or more of the STAs 106 to the AP 104a can be referred to as an uplink (UL) 140. Alternatively, a downlink 130 can be referred to as a forward link or a forward channel, and an uplink 140 can be referred to as a reverse link or a reverse channel.

A variety of processes and methods can be used for transmissions in the wireless communication system 100 between the AP 104a and the STAs 106. In some aspects, wireless signals can be transmitted using orthogonal frequency-division multiplexing (OFDM), direct-sequence spread spectrum (DSSS) communications, a combination of OFDM and DSSS communications, or other schemes. For example, signals can be sent and received between the AP 104a and the STAs 106 in accordance with OFDM/OFDMA processes. Accordingly, the wireless communication system 100 can be referred to as an OFDM/OFDMA system. As another example, signals can be sent and received between the AP 104a and the STAs 106 in accordance with CDMA processes. Accordingly, the wireless communication system 100 can be referred to as a CDMA system.

Aspects of certain devices (such as the AP 104a and the STAs 106) implementing such protocols can consume less power than devices implementing other wireless protocols. The devices can be used to transmit wireless signals across a relatively long range, for example about one kilometer or longer. As described in greater detail herein, in some embodiments, devices can be configured to establish wireless links faster than devices implementing other wireless protocols.

### Association and Authentication

Generally, in IEEE 802.1X protocols, authentication takes place between a STA and an authentication server (e.g., a server that provides authentication services, such as identity verification, authorization, privacy, and non-repudiation). For example, the AP, which functions as an authenticator, relays messages between the AP and the authentication server during the authentication process. In some instances, the authentication messages between the STA and the AP are transported using extensible authentication protocol over local area network (EAPOL) frames. EAPOL frames may be defined in the IEEE 802.11i protocol. The authentication messages between the AP and the authentication server may be transported using the remote authentication dial in user service (RADIUS) protocol or the Diameter authentication, authorization, and accounting protocol.

During the authentication process, the authentication server may take a long time to respond to messages received from the AP. For example, the authentication server may be physically located at a location remote from the AP, so the delay may be attributed to the backhaul link speed. As another example, the authentication server may be processing a large number of authentication requests initiated by STAs and/or APs (e.g., there may be a large number of STAs in a dense area, such as on the train 120, each of which are attempting to establish a connection). Thus, the delay may be attributed to the loading (e.g., traffic) on the authentication server.

Because of the delay attributed to the authentication server, the STAs 106 may be idle for long periods of time.

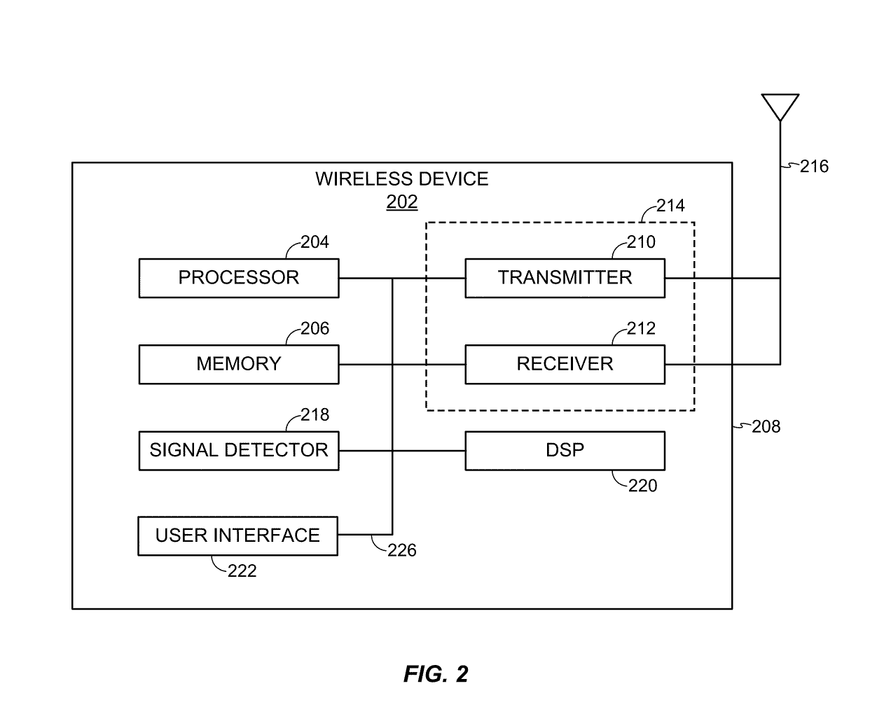

FIG. 2 shows an exemplary functional block diagram of a wireless device 202 that may be employed within the wireless communication system 100 of FIG. 1. The wireless device 202 is an example of a device that may be configured to implement the various methods described herein. For example, the wireless device 202 may comprise one of the devices 104 or 106 in FIG. 1.

The wireless device 202 may include a processor 204 which controls operation of the wireless device 202. The processor 204 may also be referred to as a central processing unit (CPU). Memory 206, which may include both read-only memory (ROM) and random access memory (RAM), may provide instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208 that may include a transmitter 210 and/or a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. The DSP 220 may be configured to generate a packet for transmission. In some aspects, the packet may comprise a physical layer data unit (PPDU).

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

The various components of the wireless device 202 may be coupled together by a bus system 226. The bus system 226 may include a data bus, for example, as well as a power bus, a control signal bus, and a status signal bus in addition to the data bus. Those of skill in the art will appreciate the components of the wireless device 202 may be coupled together or accept or provide inputs to each other using some other mechanism.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

The wireless device 202 may comprise any of wireless devices shown in FIG. 1 and may be used to transmit and/or receive communications. That is, any of wireless devices 104 or 106 may serve as transmitter or receiver devices. Certain aspects contemplate signal detector 218 being used by software running on memory 206 and processor 204 to detect the presence of a transmitter or receiver.

As described above, a wireless device, such as wireless device 202, may be configured to provide services within a wireless communication system, such as the wireless communication system 100.

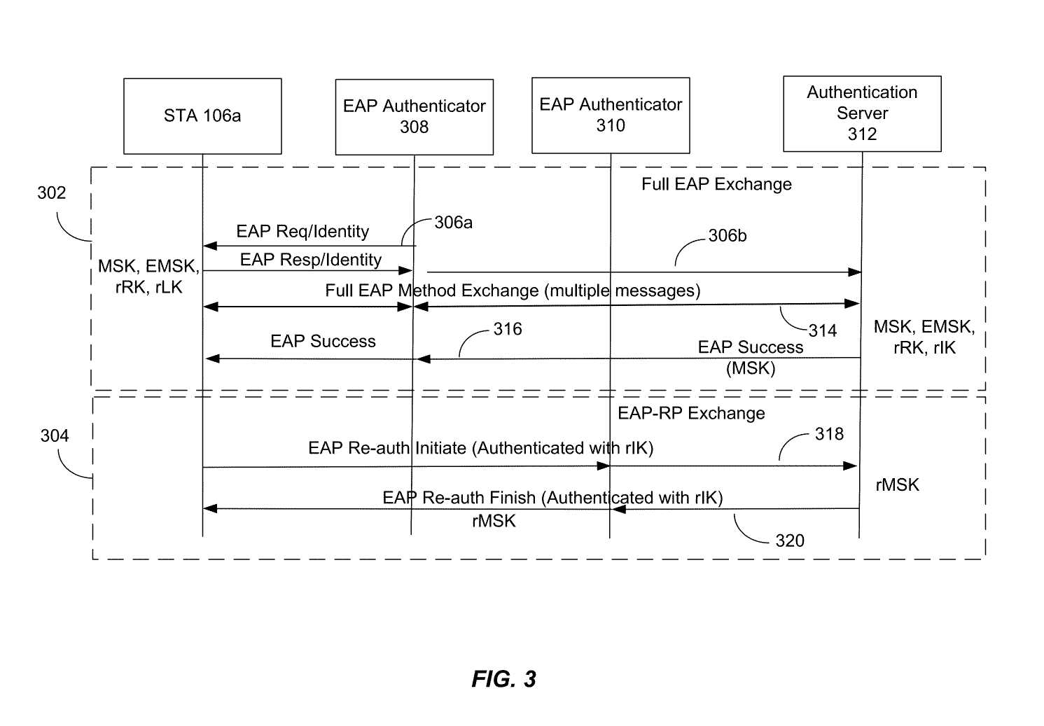

FIG. 3 shows message flows of an extensible authentication protocol (EAP) full authentication process (EAP) 302, for example, as defined in IETF RFC 2284, the contents of which are hereby incorporated by reference in its entirety, and reauthentication process (EAP-RP) 304, for example, as defined in IETF RFC 6696, the contents of which are hereby incorporated by reference in its entirety. In some aspects, the full EAP authentication 302 includes the STA 106a receiving an EAP Request/Identity message 306a from an EAP authenticator. In some aspects, the EAP authenticator 308 may be an access point or a wireless LAN controller. In response to this trigger from the authenticator, the STA 106a may initiate an ERP exchange by transmitting an EAP-Initiate/Re-authentication message, which may be included in message flows 314.

During EAP full authentication, the authentication server 312 may generate one or more of a master session key (MSK), an extended master session key (EMSK), a re-authentication root key (rRK) and a re-authentication integrity key (rIK).

When the full EAP authentication has been completed, the authentication server 312 may send an EAP success status to the STA 106a via message 316. The master session key (MSK) may also be provided to the STA 106a in message 316.

The STA 106a may then perform an EAP reauthentication process (EAP-RP) 304 with a second authenticator 310. In some aspects the second authenticator 310 may be a second access point. In some aspects the second authentication 310 may be a wireless LAN controller. The STA 106a may send an EAP re-authentication message 318 to the authentication server 312 via the EAP authenticator 310. The authentication server 312 may generate a reauthentication master session key (rMSK) and transmit an EAP re-authentication finish message 320 to the STA 106 via the EAP authenticator 310 in some aspects.

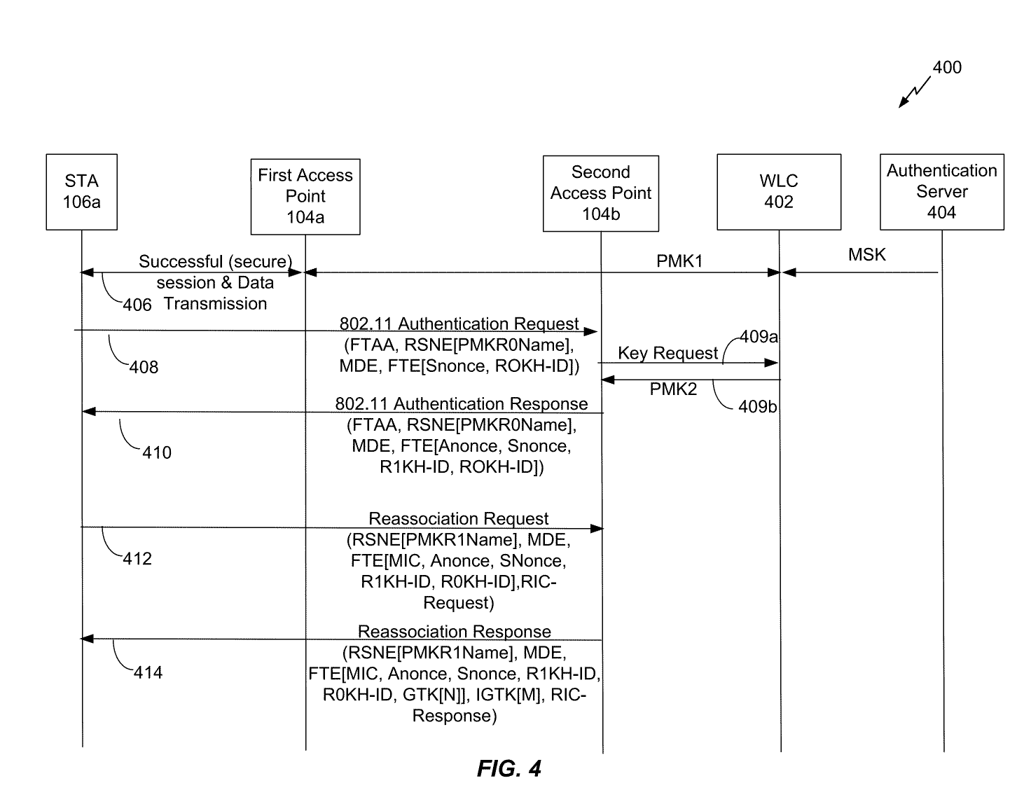

FIG. 4 shows an IEEE 802.11r fast basic service set (BSS) transition (FT) authentication and reauthentication process 400. STA 106a may first perform successful session establishment and data transmission with a first access point 104a via message flows 406. This first authentication and data transmission may be performed using IEEE 802.11 authentication. Message flows 406 may include the wireless LAN controller 402 and/or authentication server 404 in some aspects (not shown), but may not include the second access point 104b.

During authentication of the STA 106a with the first access point 104a, the authentication server 404 may provide a master session key (MSK) to the wireless LAN controller 402. From the master session key, the wireless LAN controller may derive one or more pairwise master keys (PMK1 shown) and provide at least the PMK1 to the first access point 104a. The first access point 104a may utilize the PMK1 provided by the WLC 402 to make a secure association with the STA 106a. For example, communications between the first access point 104a and the STA 106a may be encrypted using the key (i.e., PTK) derived from PMK1 provided by the WLC 402.

The STA 106a may then move within range of a second access point 104b. The STA 106a may then transmit an 802.11 authentication request 408 to the second access point 104b. In response, the AP 104b may transmit a key request message 409a to the wireless LAN controller 402. The wireless LAN controller 402 provides a second pairwise master key to the second access point (PMK2) via response key response message 409b. The second access point 104b may utilize the second pairwise master key (PMK2) to derive PTK2 and encrypt communication between the STA 106a and the second access point 104b using PTK2. The AP 104b then transmits an authentication response message 410 to the STA 106a. The STA 106a may also perform a reassociation with the second access point 104b via reassociation request/reply messages 412/414.

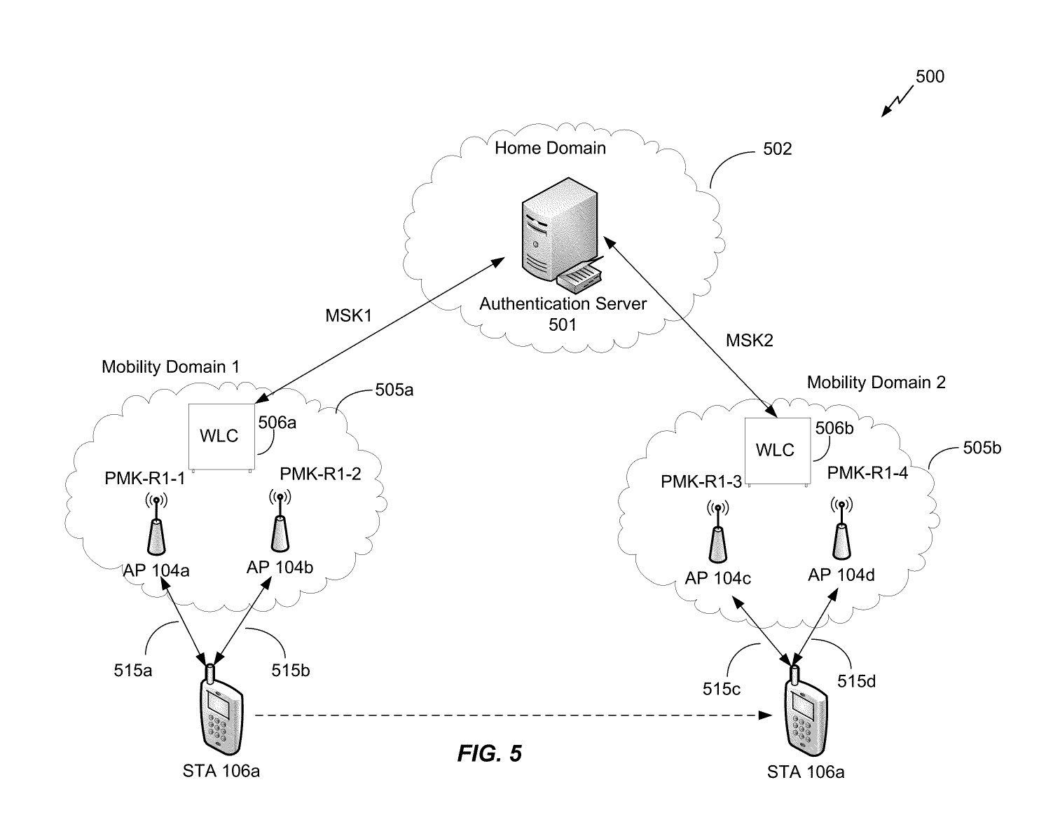

FIG. 5 is an illustration of message flows between network device components in one embodiment of an authentication method. FIG. 5 shows a home domain 502, including an authentication server 501, along with two mobility domains 505a and 505b. Within each mobility domain 505a-b are two access points, APs 104a-b, and APs 104c-d respectively. Each mobility domain 505a-b also includes a wireless LAN controller (WLC) 506a-b. The WLC's 506a-b may also be known as “RO Key holders.” A STA 106a shown at the bottom of FIG. 5 may move from the left to the right of the figure. As STA 106a moves, it may authenticate with AP 104a, then AP 104b, then AP 104c, and then AP 104d.

Authentication message exchange 515a may perform a full EAP authentication, as shown in FIG. 3. With full EAP authentication, an authentication initiated by the STA 106a will cause messages to be exchanged with the authentication server 501. For example, the authentication server 501 may create a master session key (MSK1), and provide the MSK1 to the WLC 506a. The WLC 506a may then derive a pairwise master key (PMK) based on the MSK1 and provide the PMK to the AP 104 (this key is shown as PMK-R1-1 in FIG. 5). The PMK provided to the AP 104a may also be derived based on a characteristic of the AP 104a, such as the AP 104a's media access control (MAC) address in some aspects.

The STA 106a may then authenticate with the AP 104b, via authentication message exchange 515b. Since the AP 104b is within the same mobility domain as the AP 104a, the STA 106a may determine (via beacon messages from the AP 104b) that it does not need to perform a full EAP authentication with the AP 104b, but can instead perform an authentication based on the master session key (MSK1) stored at the WLC 206a. In some aspects, the STA 106a performs a fast basic service set transition authentication as part of authentication message exchange 515b. This authentication may not require the WLC 506a to exchange messages with the authentication server 501 when the STA 106a authenticates with the AP 104b. Instead, the WLC 506a derives a second PMK, shown as PMK-R1-2 in FIG. 5 based on the first master session key (MSK1) provided by the authentication server 501 when the STA 106a authenticated with AP 104a. The second PMK may also be derived based on one or more characteristics of the AP 104b, such as the AP 104b's media access control (MAC) address in some aspects. Since no messages may need to be exchanged with the authentication server 501 when the STA 106a (authenticates with the AP 104b, the authentication message exchange 515b may occur more quickly than the authentication message exchange 515a. Additionally, load on the authentication server 501 may be reduced, relative to a solution that required the STA 106a to authentication with the authentication server 501 every time it authenticated with a new access point.

The STA 106a may then move to a location such that the AP 104b is out of range, and the STA 106a may authenticate with the AP 104c via message exchange 515c. In IEEE 802.11r, the STA 106a then performs another full EAP authentication as part of message exchange 515c, since the AP 104c is in a different mobility domain (505b) than the AP 104a (which is in mobility domain 505a). During the full EAP authentication, the authentication server 501 generates a new master session key (MSK2) and transmits the MSK2 to the wireless LAN controller (WLC) 506b. The WLC 506b then generates a PMK based on the MSK2 and also, in some aspects, based on one or more characteristics of the AP 104c. When the STA 106a moves again and connects with AP 104d, since AP 104d is in the same mobility domain as AP 104c, the STA 106a may perform an authentication via message exchange 515d. In some aspects, message exchange 515d performs a fast basic service set transition authentication. During this authentication, the WLC 506b may generate a new PMK (PMK-R1-4) based on the previously derived MSK2 received from the authentication server 501. Since the MSK2 may be stored at the WLC 506b, this authentication can occur without necessarily communicating with the authentication server 501.

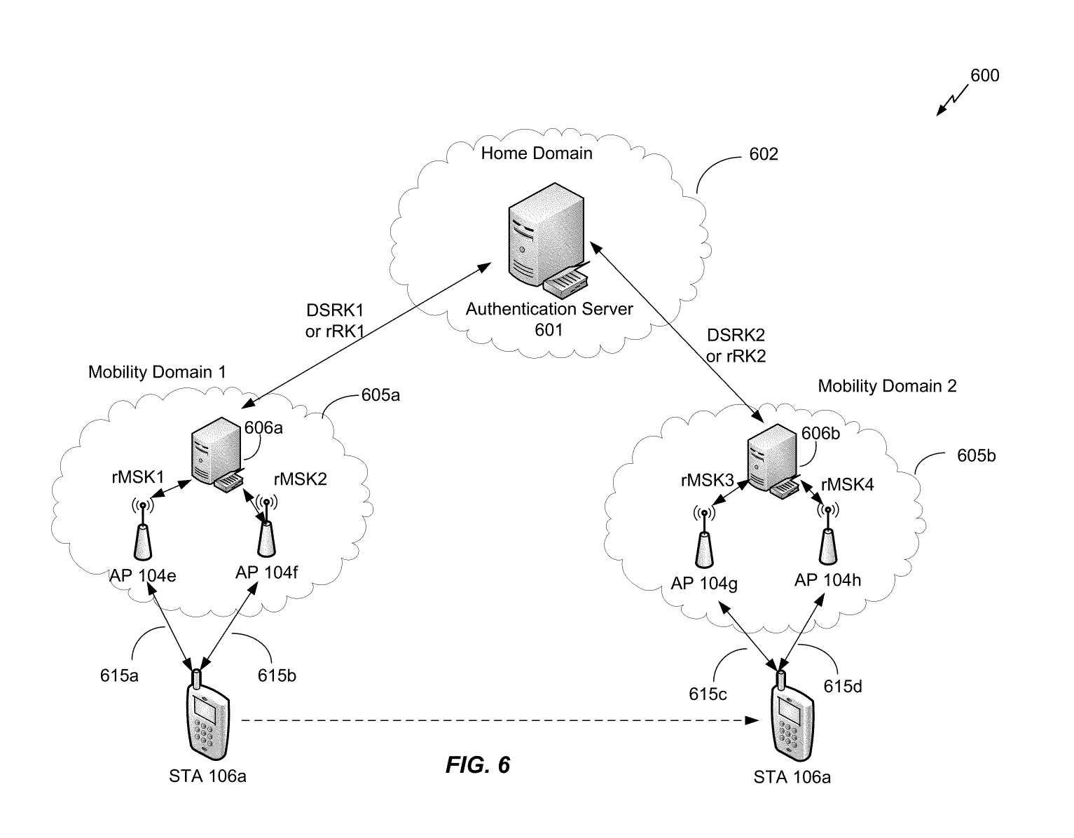

FIG. 6 illustrates message flows between wireless network components during another embodiment of an authentication process. FIG. 6 shows a home domain 602, and two mobility domains 605a-b. The home domain 602 includes an authentication server 601. Each of the mobility domains 605a-b includes a EAP Re-authentication server or local ER server 606a-b. Each of the mobility domains 605a-b each include two access points, APs 104e-f and APs 104g-h respectively.

Similar to FIG. 5, in FIG. 6, the STA 106a first authenticates with the AP 104e via message exchange 615a. This first authentication performs an extended authentication protocol reauthentication protocol (EAP-RP) authentication with the authentication server 601 as part of message exchange 615a. The AP 104e may perform relay services during the exchange between the STA 106 and authentication server 601. During the initial reauthentication with the authentication server 601 (which is performed immediately after an initial full EAP authentication), the authentication server 601 creates a reauthentication root key (rRK1) or a domain specific root key (DSRK1) and provides the rRK1 or DSRK1 to the local ER server 606a. The local ER server 606a may then derive a reauthentication master session key (rMSK1) from the DSRK1 or rRK1 and provide the rMSK1 to the AP 104e This information may be provided to the AP 104e via an EAP Finish Re-Auth message, as described in RFC 6696 in some aspects. The AP 104e may then provide this information.

The AP 104e then performs communication with the STA 106a using the rMSK1. STA 106b may then move out of range of the AP 104e and authenticate with the AP 104f via an authentication protocol message exchange 615b. Since the local ER server 606a stored the rRK1 from the STA 106a's first authentication with the AP 104e, the second authentication that occurs via message exchange 615b may not require communication with the authentication server 601. Instead, the local ER server 606a may derive a second reauthentication master session key (rMSK2) from the domain specific root key (DSRK1) or reauthentication root key rRK1 and provide the rMSK2 to the AP 104f. In some aspects, this information may be provided to the AP 104f in a EAP Finish Re-Auth message. The AP 104f may then communicate with the STA 106a based on the rMSK2.

The STA 106a may then move such that it is no longer in range of AP 104f. The STA 106a may then authenticate with the AP 104g with EAP-RP. Since the local ER server 606b does not have a key associated with the STA 106a, the local ER server 606b communicates with the authentication server 601 to obtain a re-authentication root key rRK2 or domain specific root key DSRK2 for the station 106a. The local ER server 606b then derives a reauthentication master session key for the STA 106a (rMSK3) and provides the key to AP 104g, which uses the rMSK3 key in communication with the STA 106a.

The STA 106a then authenticates with the AP 104h. Since the local ER server 606b has a key associated with the STA 106a (i.e. rRK2), the local ER server 606b derives a new reauthentication master session key (rMSK4) based on the key received from the authentication server 601 (either the DSRK2 or rRK2) for use between the STA 106a and the AP 104h. AP 104h then uses the rMSK4 to communicate with the STA 106a.

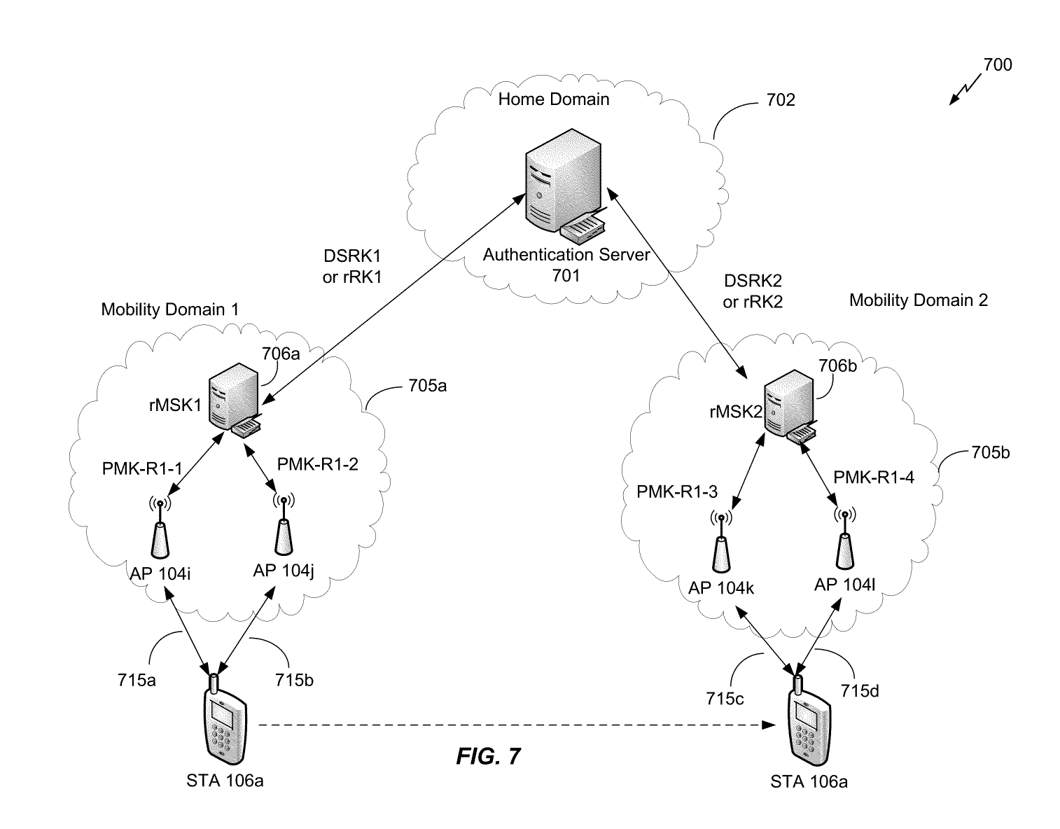

FIG. 7 illustrates message flows between wireless network components in another embodiment of an authentication process. The communications system 700 includes a home domain 702, and two mobility domains 705a-b. Within the home domain is an authentication server 701. Within each of the mobility domains 705a-b is a local ER server 706a-b respectively. In some aspects, either of the local ER servers 706a-b may be the wireless device 202 of FIG. 2. Each mobility domain 705a-b also includes two access points AP 104i-j and AP 104k-l respectively.

Similar to the authentication method described with respect to FIG. 6, the authentication server 701 provides either reauthentication root keys rRK1 and rRK2, or domain specific root keys DSRK1 and DSRK2, to the local ER server's 706a and 706b respectively. The keys may be provided in response to the STA 106a authenticating via access points connected to each of the local ER server's 706a (APs 104i-j) and 706b (AP 104k-l).

FIG. 7 shows an authentication message exchange 715a between the STA 106a and AP 104i. In some aspects, this authentication message exchange may utilize a first authentication protocol, such as an EAP reauthentication (EAP-RP) authentication protocol. In some aspects, the local ER servers 706a-b may generate a reauthentication master session key (rMSK) based on the keys provided by the authentication server 701, such as rRK1/RK2 or DSRK1/DSRK2 as shown in FIG. 7. The reauthentication master session key may then be used to generate PMK's provided to the access points AP 104i-1. For example, the local ER server 706a may derive a first reauthentication master session key (rMSK1) from the reauthentication root key rRK1 received from the authentication server 701 when STA 106a authenticates via AP 104i via authentication message exchange 715a. In some aspects, the local ER server 706a may generate a first PMK based on the reauthentication master session key rMSK1. In some aspects, this first PMK is a PMK-R0. The local ER server 706a may then generate a second PMK, such as a PMK-R1-1 as shown in FIG. 7 based on the rMSK1. The PMK-R1-1 may also be based on the PMK-R0 in some aspects. In some aspects, generation of the PMK-R1 may be additionally based on one or more characteristics of the AP 104i, such as its media access control address, and/or characteristics of the STA 106a, such as its media access control (MAC) address. The local ER server 706a may also generate, in response to an authentication message exchange 715b from the STA 106a via AP 104j, a second PMK, shown as PMK-R1-2 in FIG. 7, based also on the rMSK1. The authentication message exchange 715b may include a second authentication protocol reauthentication request from the STA 106a to the AP 104j. In some aspects, message exchange 715a is an EAP-RP exchange and authentication message exchange 715b is a fast BSS transition authentication. When the AP 104j receives the second authentication protocol reauthentication request from the STA 106a, it may request a key from the local ER server 706a. In response to receiving the key request, the local ER server 706a may generate the second PMK RMK-R1-2. Alternatively, the local ER server 706a may proactively generate a PMK for the AP 104j during or in response to the EAP-RP reauthentication. In some embodiments, the PMK-R1 for the AP 104j may be transmitted proactively to the AP 104j, such that when message exchange 715b occurs with the STA 106a, the AP 104j already has a PMK-R1 available for use with the STA 106a.

Message exchange 715c may be an EAP-RP reauthentication between the STA 106a and the AP 104k. The EAP-RP reauthentication may be passed through the AP 104k such that the STA 106a and local ER server 706b exchange EAP-RP protocol messages. Authentication message exchange 715d may utilize a second authentication protocol, for example, fast BSS transition (FT) authentication. In some aspects, the AP 104l may transmit a message to the local ER server 706b requesting a key for use in communication with STA 106a upon receiving an authentication request message as part of the second authentication protocol.

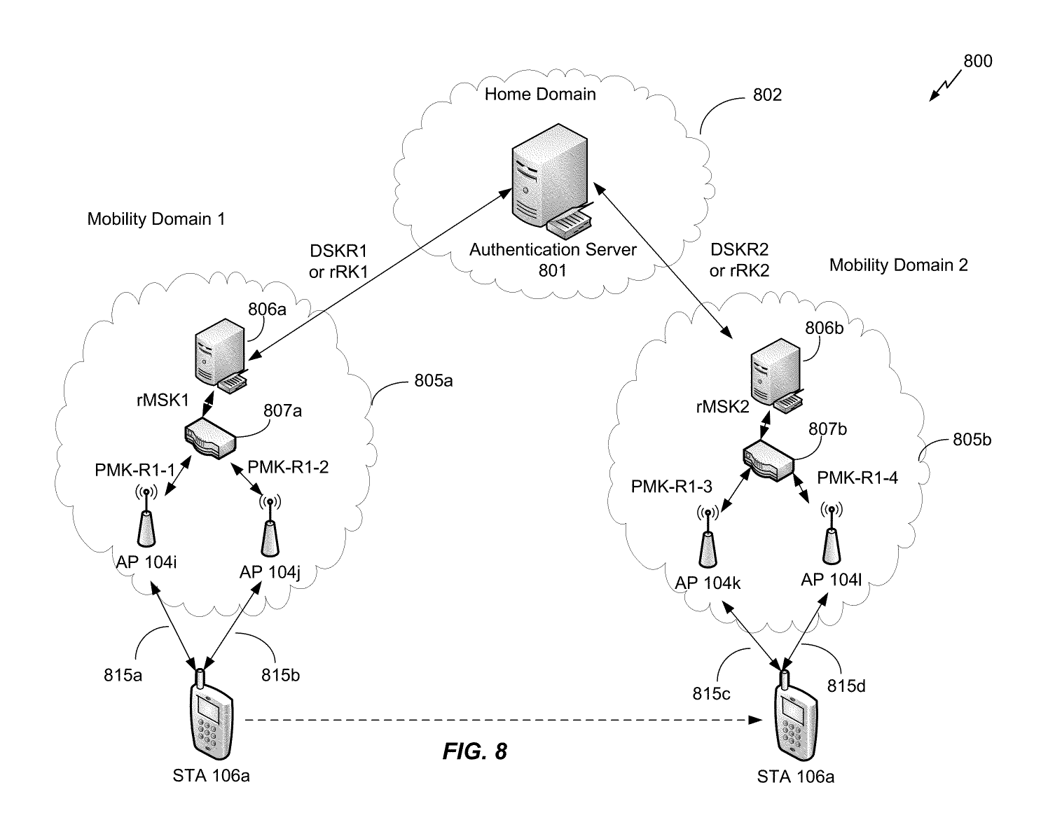

As shown in FIG. 8, in some other aspects, some functions of the local ER server 706a-b described above may be performed by multiple devices, such as local ER server 806a-b and key holder devices 807a-b. In some of these aspects, the key holder devices 807a-b may be the wireless device 202, shown above in FIG. 2.

In some mobility domains, such as those shown in FIG. 8, a local ER server 806a-b and a separate key holder device 807a-b may be used to perform authentication of mobile devices such as mobile device STA 106a. For example, in some aspects, the local ER server may derive a reauthentication master session key (such as rMSK1 and/or rMSK2 discussed above, and provide these keys to a “R0 key holder” device 807a-b. The R0 key holder devices 807a-b may then generate a PMK for an access point based on the reauthentication master session key. For example, FIG. 8 shows the key holder device 807a providing a PMK-R1-1 to the AP 104i. The key holder device 807a may have derived the PMK-R1-1 based on the rMSK1 provided by the local ER server 806a. In some aspects, an intermediate PMK, such as a PMK-R0, may first be derived from the reauthentication master session key (rMSK1 or rMSK2), and then a PMK-R1 is derived from the PMK-R0.

Returning to the description of FIG. 7, the first authentication via message exchange 715a (FIG. 4) by STA 106a occurs with AP 104i. This authentication may be performed using the authentication server 701 respectively and may utilize in some aspects an extended authentication protocol reauthentication protocol (EAP-RP). The second authentication performed via message exchange 715b may be performed without necessarily contacting the authentication server 701. For example, since the local ER server 706a (or key holder device of FIG. 8) may have stored the reauthentication master session key rMSK1, the PMK-R1-2 may be generated for the AP 104j without communicating with the authentication server 701.

When the STA 106a authenticates with AP 104k via message exchange 715c, an EAP reauthentication (EAP-RP) may be performed with the authentication server 701. The STA 106a may determine to perform an EAP-RP at least in part based on determining that the AP 104k is in a different mobility domain than the AP 104j. This information may be provided via beacon signals transmitted by AP 104j and AP 104k. The STA 106a may also determine that its authentication server 701 is accessible via the AP 104k via beacon signals transmitted by the AP 104k. The EAP reauthentication that occurs via message exchange 715c may cause the authentication server 701 to provide a reauthentication root key rRK2 to the local ER server 706b. The local ER server 706b derives a reauthentication master session key rMSK2 from the reauthentication root key rRK2. A PMK-R1-3 is then derived based on the rMSK2 (in some aspects, via an intermediate pairwise master key such as a PMK-R0). The PMK-R1-3 is then used for communication between the AP 104k and the STA 106a.

When the STA 106a authenticates with the AP 104l via authentication message exchange 715d, the local ER server 706b (or key holder device 807b in FIG. 8) may receive a key request message from the AP 104l, requesting a key for use in communication between the STA 106a and the AP 104l. Since the local ER server 706b has stored the rMSK2, it may derive a PMK-R1-4 for use in communication between the AP 104l and the STA 106a and transmit a key response message to the AP 104l including the PMK-R1-4.

In FIG. 8, the message exchange 815a may perform extensible authentication protocol reauthentication protocol (EAP-RP) authentication, as discussed above with respect to FIG. 3. Message exchange 815b may, in some aspects, perform fast basic service set transition (FT) authentication, as discussed above with respect to FIG. 4. Similarly, message exchange 815c may perform EAP-RP authentication while message exchange 815d performs FT authentication.

Similar to the messaging discussed with respect to FIG. 7, in response to the AP 104j and/or the AP 104l performing fast basic service set transition authentication with the STA 106a, the AP's 104j and/or AP 104l may transmit key request messages to the R0 key holder devices 807a and/or 807b respectively. The AP 104j and/or AP 104l may generate the PMK-R1-2 and/or PMK-R1-4 in response to the key request messages and transmit the PMKs to the APs via a key response message. Alternatively, the R0 key holder devices 807a-b may proactively transmit PMK-R1's to the AP's when the reauthentication master session key is received from the local ER servers 806a-b respectively.

With the authentication method 800 shown in FIG. 8, a single local ER server, such as the ER servers 806a-b may support multiple mobility domains (i.e., multiple key holder devices such as key holder devices 807a-b).

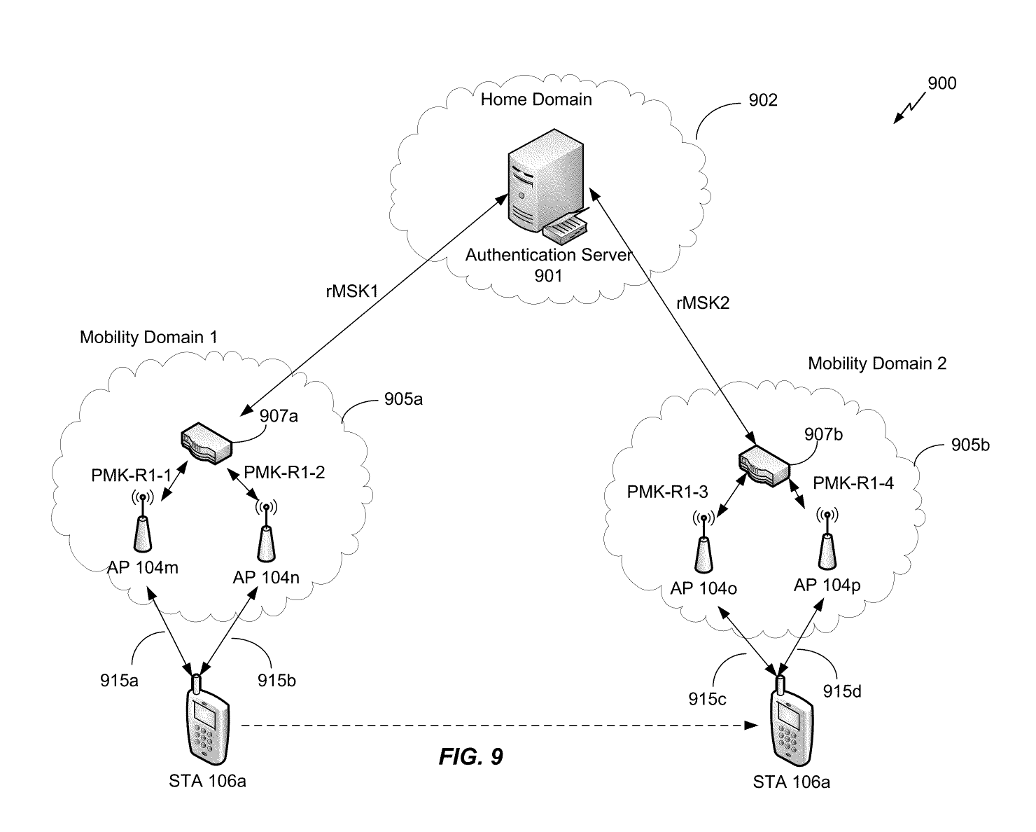

FIG. 9 illustrates message flows between wireless network components in another embodiment of an authentication process. In the authentication method 900, no local ER servers exist within the mobility domains 905a-b. Therefore, instead of the authentication server 901 providing a reauthentication root key to the local ER servers, as shown for example, in FIG. 7 or 8 when the authentications servers 701 and 801 provided the reauthentication root keys rRK1 and rRK2 to local ER servers 806a-b respectively, the authentication server 901 provides a reauthentication master session key rMSK1 and rMSK2 to the key holder devices 907a-b respectively. In some aspects, the key holder devices 907a-b may be the wireless device 202 shown in FIG. 2. The key holder devices 907a-b may then operate similarly to the key holder devices 807a-b described with respect to FIG. 8 above. For example, each of message exchanges 915a and 915c may perform an EAP-RP authentication, while message exchanges 915b and 915d perform a fast basic service set transition (FT) authentication.

In FIG. 9, the message exchange 915a may perform extensible authentication protocol reauthentication protocol (EAP-RP) authentication, as discussed above with respect to FIG. 3. Message exchange 915b may, in some aspects, perform fast basic service set transition (FT) authentication, as discussed above with respect to FIG. 4. Similarly, message exchange 915c may perform EAP-RP authentication while message exchange 915d performs FT authentication.

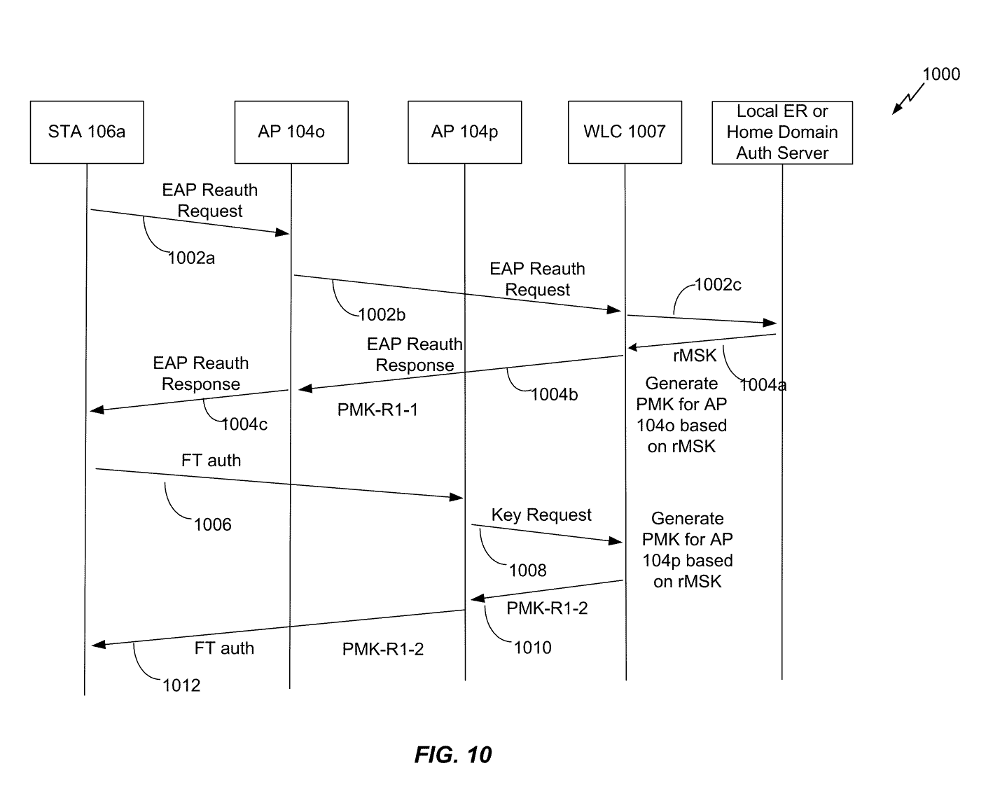

FIG. 10 is a message sequence diagram between an STA 106a, two access points AP 104o-p, a key holder device, in this case a wireless LAN controller 1007, and a local ER server, such as local ER server 706a or 706b in FIG. 7, or an authentications server, such as any of authentication servers 801, or 901. In some aspects, the key holder device 1007 may be wireless device 202 of FIG. 2 and/or a key holder device 807a-b from FIG. 8.

Before the message sequence 1000 occurs, the STA 106a may have performed a full EAP authentication within a first mobility domain with its home authentication server. The AP 104o may be in a second mobility domain different than the first mobility domain. In some aspects, the STA 106a may determine the AP 104o is in the second mobility domain via beacon signals transmitted by the AP 104o. The STA 106a may also determine that its home authentication server is accessible via AP 104o. The STA 106a then transmits an EAP reauthentication request 1002a to AP 104o, indicating its home authentication server. The EAP reauthentication request 1002 may be forwarded by the AP 104o to the wireless LAN controller (WLC) 1007 as message 1002b. The WLC 1007 may transmit the EAP reauthentication request message to a local ER server or the home domain authentication server indicated by the EAP reauthentication request as message 1002c.

In response, the local ER server or the home domain authorization server generates a reauthentication master session key (rMSK) for the STA 106a (shown as “rMSK”) and transmits a reauthentication response 1004a to the WLC 1007. The WLC 1007 may store the reauthentication master session key (rRK). The WLC 1007 then generates a pairwise master key based on the reauthentication master session key (rMSK). The WLC 1007 may also generate a second pairwise master key based on the first pairwise master key. In some aspects, the first pairwise master key is a PMK-R0, while the second pairwise master key is a PMK-R1. The WLC 607a then transmits a EAP reauthentication response message 1004b to the AP 104o. The message 1004b may include a PMK, such as the PMK-R1 which is based on the reauthentication master session key received from the local er server or home domain authentication server. The AP 1040 then forwards the reauthentication to the STA 106a as message 1004c.

Next, the STA 106a transmits a fast basic service set transition (FT) authentication message to the AP 104p. In response, the AP 104p requests a key from the WLC 1007 via key request message 1008. The WLC 1007 then generates a second PMK for use by the AP 104p for communication with the STA 106a. This PMK may be generated based on one or more properties of the STA 106a and/or the AP 104p. This PMK, “PMK-R1-2” is transmitted to the AP 104p in a key response message 1010.

The AP 104p may complete the FT authentication with the STA 106a via message 1012 after receiving the PMK-R1-2 from the WLC 1007.

In some other aspects, the PMK-R1-2″ may be proactively generated by the WLC 1007 before receipt of the key request message 1008. For example, the PMK-R1-2 may be generated during the EAP-RP exchange 1002/1004 with the STA 106a. In some aspects, the PMK-R1-2 may be transmitted to the access point by the WLC 1007 even before the FT authentication message 1006 is transmitted by the STA 106a.

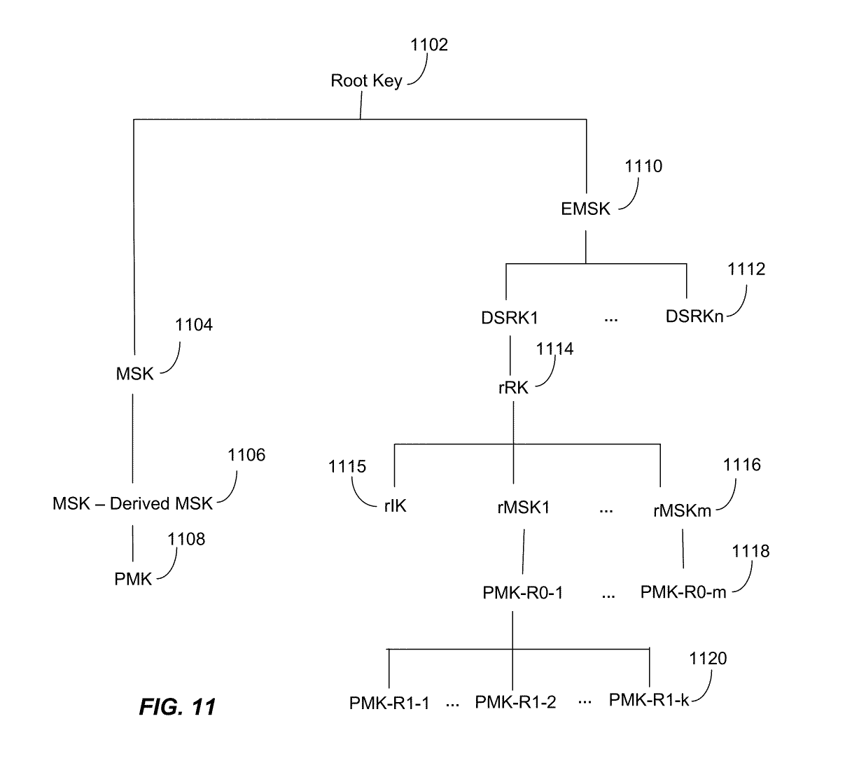

FIG. 11 shows a key hierarchy in an authentication method, such as the authentication method shown in FIGS. 8-10. FIG. 11 shows a root key 1102. A master session key (MSK) 1104 may be derived from the root key 1102. One or more derived master session keys (MSKs) 1106 may be derived from the master session key 1104. A pairwise master key (PMK) 1108 may be derived from the derived master session key 1106.

An extended master session key (EMSK) 1110 may be derived from the root key 1102. In some aspects, the EMSK may be at least 64 bits, and derived as a result of mutual authentication between an STA and authentication server per RFC 3748. In some aspects, the EMSK may be named using a extensible authentication protocol session identifier and a binary or textual indication per RFC 5247. A session identifier may be defined based on the extensible authentication protocol (EAP) method (per RFC 5217 appendix). For EAP-TLS (RFC 5216):
Key_Material=TLS-PRF-128(RK, “client EAP encryption”, client.random∥server.random) (TLS-PRF-128 produces1024 bits output)
MSK=Key_Material(0,63) (i.e., higher 512 bits of Key_Material)
EMSK=Key_Material(64,127) (i.e., lower 512 bits of Key_Material)
Session-ID=0x0D∥client.random∥server.random.
   where client.random and server.random are the random numbers (32B each) exchanged between server (AS) and client (STA) during authentication, and TLS-PRF-X outputs a X octets (i.e., 8X bits) value and is defined in RFC4346.

One or more domain specific root keys (DSRK) 1112 may be derived from the EMSK 1110. A reauthentication root key 1114 may be derived from one of the domain specific root keys 1112. In some aspects, the derivation of the reauthentication root key 1114 is specified in section 4.1 of RFC 6696. For example, the reauthentication root key 1114 may be defined by:
rRK=KDF(K,S), where:
   K=EMSK or K=DSRK and
   S=rRK Label|“\0”|length

The rRK Label is an IANA-assigned 8-bit ASCII string: EAP Re-authentication Root Key@ietf.org assigned from the “USRK Key Labels” name space in accordance with the policy stated in RFC 5295.

The Key Derivation Function (KDF) and algorithm agility for the KDF are as defined in RFC 5295.

A reauthentication integrity key 1115 (rIK) may be derived from the reauthentication root key 1114. In some aspects, the reauthentication integrity key 1115 may be derived as specified in RFC 6696. For example, the rIK may be derived as follows:
rIK=KDF(K, S), where
   K=rRK and
   S=rIK Label|“\0”|cryptosuite|length

The rIK Label is the 8-bit ASCII string: Re-authentication Integrity Key@ietf.org. The length field refers to the length of the rIK in octets and is encoded as specified in RFC 5295.

One or more reauthentication master session keys (rMSK) 1116 may be derived from a reauthentication root key 1114. In some aspects, a rMSK 1116 may be derived according to RFC 6696. For example, the rMSK may be derived as follows:
rMSK=KDF(K, S), where
   K=rRK and
   S=rMSK Label|“\0”|SEQ|length
      The rMSK Label is the 8-bit ASCII string: Re-authentication Master Session Key@ietf.org
      The length field refers to the length of the rMSK in octets and is encoded as specified in RFC 5295.

As discussed above with respect to FIGS. 8-10, one or more pairwise master keys (PMKs) 1118 may be derived from a reauthentication master session key 1116. As shown in FIG. 11, the pairwise master keys derived from the reauthentication master session key 1116 are PMK-R0 pairwise master keys. One or more second level pairwise master keys 1120 may be derived from a single PMK 1118. As shown in FIG. 11, the pairwise master keys 1120 are PMK-R1 pairwise master keys. In any of the key derivations discussed above, a HMAC-SHA-256 may be used as a default key derivation function (KDF).

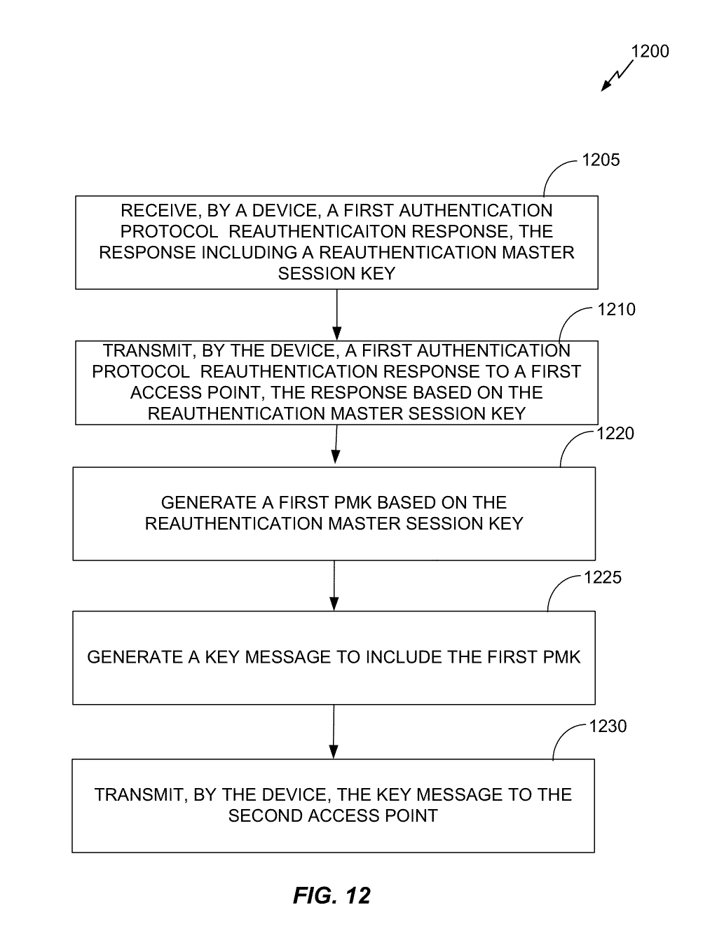

FIG. 12 is a flowchart of a method of authenticating a wireless device. In some aspects, the process 1200 may be performed by the wireless LAN controllers described above with respect to FIGS. 7-10, and/or the wireless device 202 of FIG. 2. In some aspects, process 1200 is performed by an R0 key holder device as defined in the 802.11 fast transition key holder architecture.

In some aspects, FIG. 12 may provide for interoperability between two different authentication protocols. For example, a first authentication protocol may provide some advantages over a second authentication protocol. The second authentication protocol may be widely deployed within a wireless network. Deploying the first authentication protocol widely throughout the network may be cost prohibitive and may require a substantial period of time before the deployment can be completed such that the first authentication protocol can be utilized in its entirely. While a second authentication protocol may provide some advantages over the first authentication protocol, deploying the second authentication protocol widely throughout a wireless network may be expensive and may not be accomplished for a substantial period of time in the future. Process 1200 described below may allow some implementations to leverage the benefits of the first a

In block 1205, a first authentication protocol reauthentication response for the mobile device is received. In some aspects, the reauthentication response is received from a local ER server, or an authentication server. In some aspects, the first authentication protocol is the extensible authentication protocol reauthentication protocol (EAP-RP). The reauthentication response includes a reauthentication master session key. The reauthentication master session key may be decoded from the reauthentication response. The reauthentication master session key may be derived from a reauthentication root key. For example, as shown in FIG. 11, a rMSK 1116 may be derived from a rRK 1114.

In some aspects, the reauthentication response received in block 1105 from the ER server or authentication server is in response to a first authentication protocol reauthentication request transmitted by the device to the local ER or authentication server. The device may receive a reauthentication request for the mobile device from a first access point. The device may then relay the reauthentication request received from the first access point to the local ER server or a home authentication server indicated by the request.

In some aspects, the device generates a first PMK based on the reauthentication master session key included in the reauthentication response. In some aspects, the first PMK is a PMK-R0. A second PMK may then be generated based on the first PMK. In some aspects, this second PMK is a PMK-R1 of a fast transition keyholder architecture. In some aspects, the second PMK is generated based on one or more characteristics of the mobile device and/or the first access point. In some aspects, block 1205 may be performed by the receiver 212 of wireless device 202.

In block 1210, a first authentication protocol reauthentication response is transmitted to the first access point. The first authentication protocol reauthentication response is based on the reauthentication master session key. In some aspects, the first authentication protocol reauthentication response is based on the reauthentication master session key because it includes a PMK, such as the PMK-R1 discussed above, derived from another PMK, such as a PMK-R0, which is derived from the reauthentication master session key. In some aspects, block 1210 may be performed by the transmitter 210 of wireless device 202.

In some aspects, a key request message for communication between a second access point and a mobile device is received from the second access point. In some of these aspects, the key request message is received in response to the second access point receiving a second authentication protocol authentication request for the mobile device. In some aspects the second authentication protocol request is a fast basic service set (BSS) transition (FT) authentication request. In some aspects, the second authentication protocol is 802.11 authentication using the open system authentication algorithm. In some other aspects, the second authentication protocol authentication is 802.11 authentication using simultaneous authentication of equals (SAE).

In block 1220, a PMK is generated. The PMK generated in block 1220 may be based on the reauthentication master session key decoded from the first authentication protocol authentication response received from the ER (or authentication) server in block 1205. In some aspects, the PMK is generated based on one or more properties of the mobile device and/or the second access point. For example, as discussed above, a PMK-R0 may be generated based on the reauthentication master session key. The PMK generated in block 1220 may be based on the PMK-R0 discussed above (which is based on the reauthentication master session key). The PMK generated in block 1220 may be a PMK-R1 in some aspects. While FIG. 12 refers to the PMK generated in block 1220 as a first PMK, with respect to the PMK's discussed above with respect to block 1205-1210, it may be a third PMK. In some aspects, the PMKs discussed above may be generated in accordance with the IEEE 802.11r protocol standard. In some aspects, block 1220 may be performed by the processor 204 of wireless device 202.

In block 1225, a key message is generated to include the PMK generated in block 1220. In some aspects, block 1225 may be performed by the processor 204 of wireless device 202.

In block 1230, the key message is transmitted to the second access point. The PMK generated in block 1225 is used for communication between the mobile device and the second access point. For example, the PMK may be used to encrypt data transmitted between the second access point and the mobile device.

In response to receiving the key message including the PMK for the second access point, the second access point may complete a second authentication protocol. In some aspects, completing the second authentication protocol includes transmitting a fast basic service set (BSS) transition (FT) authentication response. In some aspects, the second authentication protocol is an 802.11 authentication response using either open system authentication algorithm or SAE. In some aspects, block 1230 may be performed by the transmitter 210 of wireless device 202.

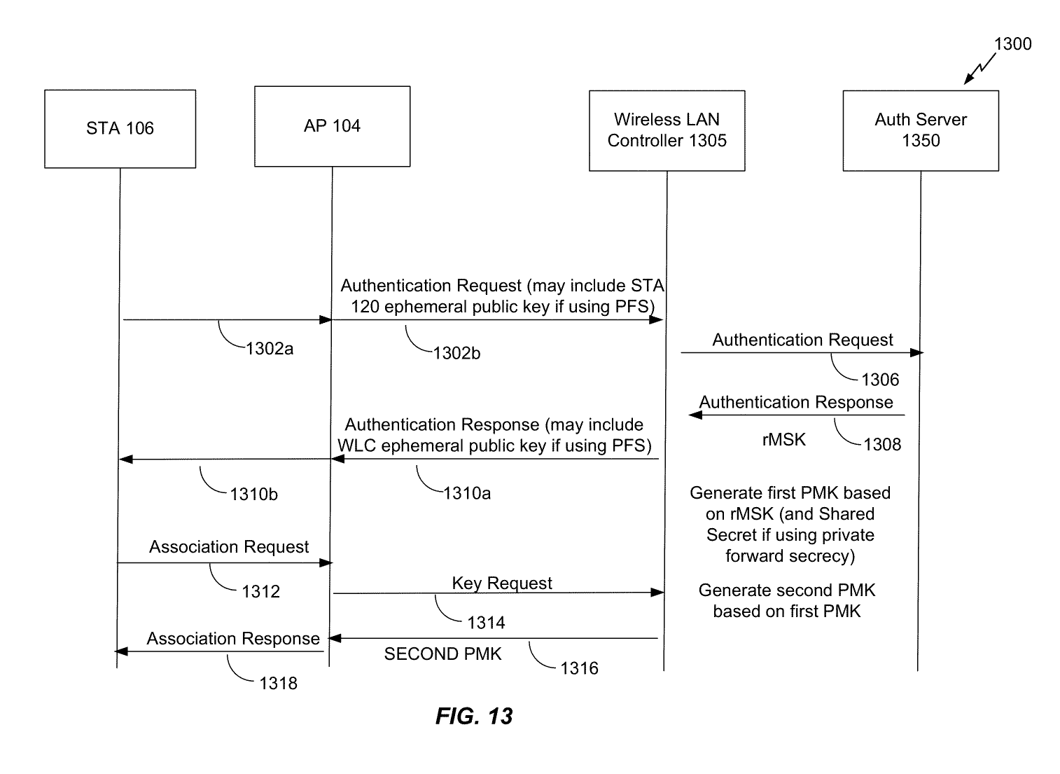

FIG. 13 is a message flow diagram of a shared key authentication. Message flow 1300 shows a shared key authentication request 1302a-b transmitted by the STA 106 to the wireless LAN controller 1305 (WLC). The shared key authentication request 1302a-b may be the authentication request defined by IEEE 802.11ai, discussed above. In some aspects, the authentication request 1302 may be transmitted to the AP 104 as 1302a and then relayed to the WLC 1305 as 1302b. In embodiments of message flow 1300 that perform a shared key authentication using perfect forward secrecy (PFS), the STA 106 and Wireless LAN controller (WLC) 1305 may perform a diffie hellman key exchange. This exchange may be facilitated in part by inclusion of an ephemeral public key for the STA 106 in the authentication request 1302a-b. As a result of receiving the authentication request 1302a-b, the WLC 1305 transmits authentication request 1306 to the authentication server 1350.

A shared key authentication response 1308 provides a reauthentication master session key (rMSK) to the WLC 1305. A first pairwise master key may also be generated based on the reauthentication master session key. In some aspects, the first pairwise master key may also be generated based on the shared secret. In some aspects, the first pairwise master key is generated in accordance with the IEEE 802.11 PMK-R0 except as described above.

An authentication response 1310b is then transmitted by the WLC 1305 to the STA 106 (perhaps first to the AP 104 as 1310a which then replays the message as 1310b to the STA 106). In aspects that utilize private forward secrecy (PFS), the authentication response 1310a-b may include an ephemeral public key of the WLC 1305. Since both the WLC 1305 and STA 106 now have each others ephemeral public keys, they can each derive a shared secret to use as a shared key for communications between them.

The STA 106 then generates an association request message 1312. The association request message 1312, may be an IEEE 802.11 association request, in some aspects. The association request message 1312 may enable the access point receiving the association request to allocate resources for and to synchronize with a radio of the station requesting association.

In response to receiving the association request message 1312, the access point may determine whether it can associate with the requesting station STA 106, and if so, determine an association identifier for the STA 106.

In some aspects, a PMK for use between the STA 106 and the AP 104 is “requested” or “pulled” from the WLC 1305 in response to the AP 104 receiving the association request message 1312. In these aspects, when the AP receives the association request message 1312, the AP 104 generates and transmits a key request message to the WLC 1305, requesting a key for use in communication with the STA 106. Upon receiving the key request message 1314, the WLC 1305 may transmit a second PMK to the AP in message 1316. The second PMK may be derived from the first pairwise master key, and also be derived based on one or more characteristics of the AP 104, such as its MAC address or capabilities. The second PMK may be generated for use in security association and/or communication between the STA 106 and AP 104. In some aspects, the second PMK is derived in accordance with IEEE 802.11 PMK-R1 procedures, and the first PMK is derived in accordance with IEEE 802.11 PMK-R0 procedures, except as described above.

When the AP 104 receives the second PMK, it may then respond to the STA 106 with an association response message 1318. The association response message 1318 may include data derived from the second PMK received in message 1316. The AP may then utilize the second PMK (as for example, a PMK-R1) for secure communication with the STA 106.

In some other aspects (not shown), the second PMK may be “pushed” asynchronously to the AP 104 by the WLC 1305 when the first PMK is generated. For example, in some aspects, the WLC 1305 may, upon generating a first PMK for a particular station, push second PMKs for the station to each access point with which it is in communication. Each access point will have its own individual second PMK for a particular station. In these aspects, no key request message 1314 may be transmitted to the WLC 1305 when the association request message 1312 is received by the AP 104. Instead, upon receiving the association request message 1312, the AP 104 may consult an internal storage of second PMKs received from the WLC 1305 to determine if it has a second PMK (such as a PMK-R1) stored for the STA 106. If it identifies the appropriate second PMK, the AP 104 may complete the association process with the STA 106a based on the stored second PMK.

In some aspects, the second PMK may be provided to the AP 104 as part of the authentication response message 1310a. In these aspects, there may be no need for the messages 1314 and 1316.

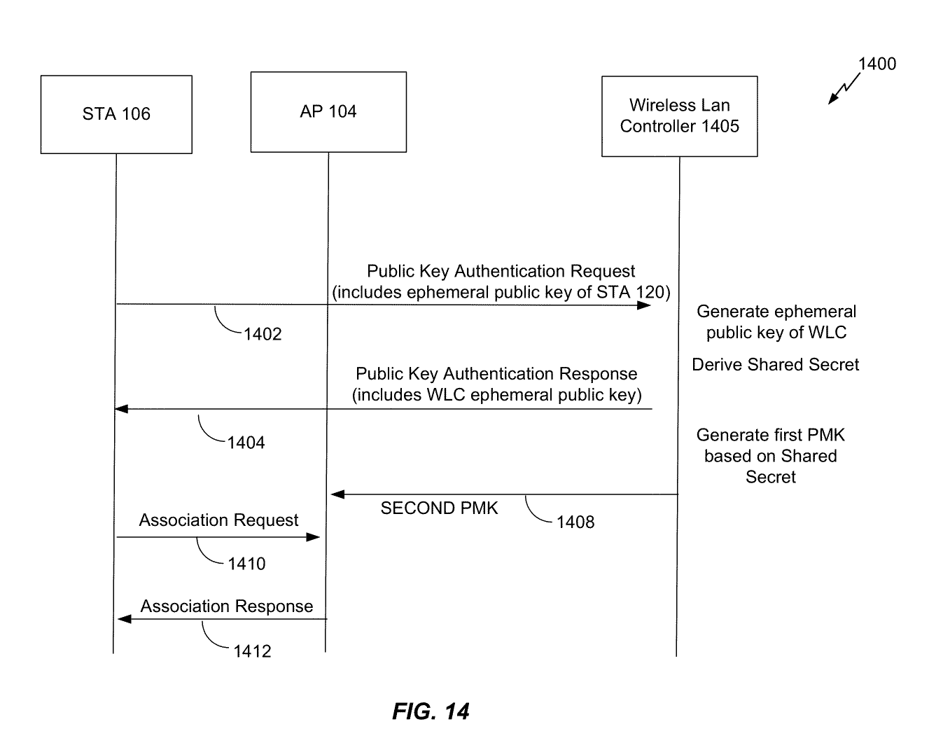

FIG. 14 is a message flow diagram of a public key authentication. The STA 106 transmits a public key authentication request message 1402 to the wireless LAN controller (WLC) 1405. The public key authentication request message 1402 may be relayed to the WLC 1405 via the AP 104 in some aspects. The public key authentication request message 1402 includes an ephemeral public key of the STA 106. Upon receiving the public key authentication request message 1402, the WLC 1405 generates its own ephemeral public key. In some aspects, the ephemeral public key may be pre-generated before the WLC 1405 receives the public key authentication request message 1402. The WLC 1405 then transmits a public key authentication response message 1404 to the STA 106, in some aspects relayed by the AP 104. The public key authentication response message 1404 includes the WLC's 1405 ephemeral public key. After message exchange 1402 & 1404, both the STA 106 and WLC 1405 have each other's ephemeral public keys. Each of the STA 106 and WLC 1405 may then derive a common shared secret based on the two public keys. Once the shared secret is derived, the WLC 1405 may derive a first pairwise master key based on the shared secret (e.g. a PMK-R0 in some aspects) for use in communications involving the STA 106 and the wireless LAN controller (WLC) 1405. The WLC 1405 may also generate a second pairwise master key (in some aspects, a PMK-R1) for use by the AP 104 in secure association and/or communications with the STA 106 based on the first pairwise master key. The second pairwise master key may also be generated by the WLC 1405 based on one or more characteristics of the AP 104, such as its media access control (MAC) address or one or more capabilities of the AP 104.

In contrast to message flow 1300 of FIG. 13, message flow 1400 shows a “push” model of second PMK distribution from the WLC 1405 to the AP 104. Whereas FIG. 13 showed the key request message 1314 transmitted from the AP 104 to the WLC requesting a PMK for use in secure association and/or secure communication with the STA 106, in FIG. 14, the second PMK, which is derived from the first PMK, may be asynchronously transmitted to the AP 104 upon generation of the first PMK by the WLC 1405. This is shown by message 1408 including the second PMK, which is derived base on the first PMK by the WLC 1405. The WLC 1405 may also derive the second PMK based on one or more characteristics of the AP 104, such as its media access control (MAC) address or capabilities. Upon receiving the second PMK via message 1408, the AP 104 may store the second PMK in a stable storage, along with information associating the second PMK with the STA 106. In some aspects, the second PMK may be included in the message 1404. In this case, message 1408 may be unnecessary.

Since FIG. 14 shows the second PMK being asynchronously transmitted to the AP 104, the STA 106 may transmit an association request message 1410 to the AP 104 after the second PMK has been received from the WLC 1405 via message 1408. When the association request message 1410 is received, the AP 104 may consult its stable storage discussed above to identify whether an appropriate PMK is available for use in secure association and/or communications with the STA 106. Upon finding the second PMK originally received in the message 1408 in its stable storage, the AP 104 may transmit the association response message 1412 to the STA 106 based on the second PMK. The AP 104 may then securely associate and/or communicate with the STA 106 via the second PMK.

In other aspects, a “pull” model of second PMK distribution to the AP 104 may be used with public key authentication. For example, in some aspects, the message flow 1400 could utilize the pull mode of PMK distribution, as shown in FIG. 13 with respect to the exchange of messages 1312, 1314, 1316, and 1318.

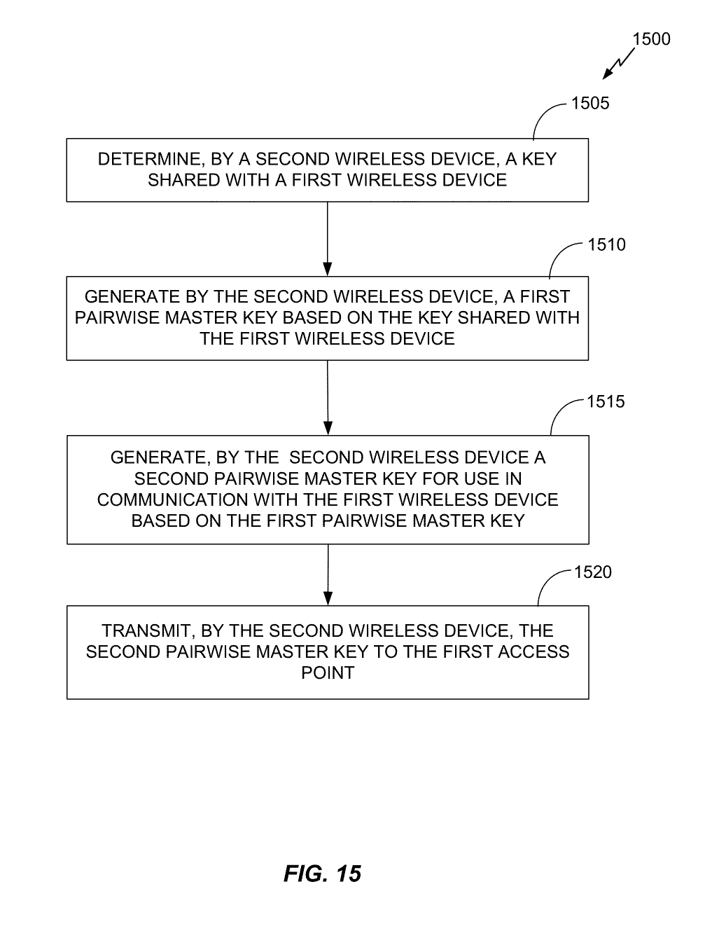

FIG. 15 is a flowchart of a method of authenticating a first device. In some aspects, the process 1500 may be performed by any of the wireless LAN controller (WLCs) devices described above with respect to FIGS. 13 and 14, and/or the wireless device 202 of FIG. 2. For example, in some aspects, the memory 206 may store instructions that configure the processor 204 to perform one or more of the functions described below with respect to FIG. 15. In some aspects, process 1500 is performed by an R0 key holder device as defined in the IEEE 802.11 fast transition key holder architecture. In some aspects, one or more of the first, second, and third devices may be or may not be wireless devices.

In some aspects, the process 1500 may be integrated with the process 1200. For example, process 1500 may be included as part of block 1220. For example, the second pairwise master key discussed below with respect to process 1500 may be equivalent to the first pairwise master key discussed above with respect to process 1200.

In some aspects, FIG. 15 may provide for interoperability between two or even three different authentication protocols. For example, a first authentication protocol may provide some advantages over a second authentication protocol. The second authentication protocol may be widely deployed within a wireless network. Deploying the first authentication protocol widely throughout the network may be cost prohibitive and may require a substantial period of time before the deployment can be completed such that the first authentication protocol can be utilized in its entirely.

While the first authentication protocol may provide some advantages over the second authentication protocol, deploying the first authentication protocol widely throughout a wireless network may be expensive and may not be accomplished for a substantial period of time in the future. Process 1500 described below may allow some implementations to leverage the benefits of the first authentication protocol without deploying all of the components necessary for a full implementation of the first authentication protocol, and instead relying on the already deployed components of the second authentication protocol.

In block 1505, a shared key is determined. The key is shared with a first device. In some aspects, the shared key is a master session key, and may be determined via an extensible authentication protocol (EAP) exchange between the first device and a second device. In some aspects, the process 1500 is performed by the second device. In some aspects, the extensible authentication protocol exchange that determines the master session key is a shared key authentication that does not utilize perfect forward secrecy (PFS). In some aspects, the master session key may be received from an authentication server as part of the EAP authentication protocol, as shown in FIG. 3.

In some aspects, the shared key is a reauthentication master session key, which is determined by performing extensible authentication protocol reauthentication protocol. In some aspects, the extensible authentication protocol reauthentication protocol exchange that determines the reauthentication master session key is a shared key authentication that does not utilize perfect forward secrecy (PFS). In some aspects, the reauthentication master session key may be received from an authentication server as part of performing the EAP-RP protocol, as shown in FIG. 3.

In some aspects, the reauthentication master session key may be derived as: rMSK=KDF (K, S) where K=rRK and S=rMSK label|“\0”|SEQ \ length. The rMSK label is an 8-bit ASCII string: “Re-authentication Master Session Key@ietf.org.” The length field refers to the length of the rMSK in octets. The rRK may be derived from an EMSK or DSRK (for example, as shown in FIG. 11).

In some aspects, the shared key is a shared secret. The shared secret may be determined in some aspects via a diffie hellman key exchange with the first device. In some aspects, one or more of the functions discussed above with respect to block 1505 may be performed by the processor 204. For example, a means for determining the shared key may include the processor 204. As another example, a means for performing extensible authentication protocol reauthentication protocol may include one or more of the processor 204, memory 206, and the transmitter 210. For example, instructions stored in the memory 206 may configure the processor 204 to perform an extensible authentication protocol-reauthentication protocol.

In block 1510, a first pairwise master key is generated based on the key shared with the first device. In some aspects, the first pairwise master key is generated based on an intermediate key. In some aspects, the intermediate key may be generated based on a nonce derived from the first device. In some aspects, the intermediate key may be generated based on a nonce derived from the second device. In some aspects, the intermediate key may be generated based on the shared key. In some aspects, the intermediate key may be generated based on a combination of two or more of the nonce generated by the first device, nonce generated by the second device, and the shared key. In some aspects, the intermediate key is generated based on a key derivation function (KDF). In some aspects, the KDF may be a hash based message authentication code (HMAC). For example, in some aspects, the intermediate key may be generated based on Equation 1 below:

Intermediate Key=HMAC-Hash(SNonce∥ANonce,IKM) (1)

Where:
SNonce is a nonce generated by the first device
ANonce is a nonce generated by the second device
IKM is:
   MSK if EAP full authentication is performed
   rMSK if shared key authentication is performed without perfect forward secrecy (PFS),
   rMSK|ss (i.e. concatenation of the rMSK and ss) in that order if using shared key authentication with perfect forward secrecy ss if public key authentication is used.
   Where:
      MSK is a master session key derived from an authentication server performing full EAP authentication rMSK is a reauthentication master session key derived by an authentication server and sent to the second device as a result of performing EAP-RP (as defined in RFC 6696) ss is a shared secret established as a result of Diffie-Hellman key exchange between first device and second device.

In some aspects, the result of the HMAC-Hash function may be truncated, for example, to 256 bits in some aspects. In some aspects, the intermediate key derived above may be used in substitution for an “XXKey” as described in the IEEE 802.11 Fast basic service set transition (FT) authentication.

An alternative implementation may derive the intermediate key as:

Intermediate key=KDF(PMK,“FILS PTK Derivation,”SPA∥AA∥SNonce∥ANonce) where:

where:
KDF is a key derivation function using 384, 640, or 1024 bits
PMK is from the PMKSA, either created from an initial FILS connection or from a cached PMKSA, when PMKSA caching is used. In some aspects, PMK is derived from rMSK
SPA is an STA's MAC address and the AA is the AP's BSSID
SNonce is the STA's nonce and ANonce is the AP's nonce

In some aspects, after the intermediate key is derived as described above, additional key derivation occurs as follows:
R0-Key-Data=KDF-384(intermediate key, “FT-R0”, SSIDlength∥SSID∥MDID∥R0KHlengh∥R0KH-ID∥S0KH-ID)
PMK-R0=L(R0-Key-Data, 0, 256)
PMK-R0Name-Salt=L(R0-Key-Data, 256-128)
PMKR0Name=Truncate-128(SHA-256(“FT-R0N”∥PMK-R0Name-Salt))
where “FT-R0N” is 0x46 0x54 0x2D 0x52 0x30 0x4E

### Where:

KDF-384 is a key derivation function using SHA-384.
MDID is a mobility domain identifier
R0KH-ID is a PMK-R0 Key Holder Identifier
S0KH-ID is a Supplicant Key holder Identifier

In some aspects, the first pairwise master key is a PMK-R0 as described above. In some aspects, the first pairwise master key may be generated based on a second key shared with the first device. For example, in aspects where the second device shares a reauthentication master session key with the first device, a shared secret may also be shared with the first device. The shared secret may be generated via a diffie-hellman key exchange with the first device. In these aspects, the first pairwise master key may be generated based on both of the shared keys (i.e. the reauthentication master session key and the shared secret). In some aspects, the two shared keys are concatenated, and the first pairwise master key is generated based on the concatenation. For example, in some aspects, the shared secret follows the reauthentication master session key in the concatenation (i.e. rMSK|SS). In some aspects, one or more functions discussed above with respect to block 1510 may be performed by the processor 204. In some aspects, the processor 204 may comprise a means for concatenating as described above.

In block 1515, a second pairwise master key is generated for a first access point to use for secure association and/or secure communication with the first device. The second pairwise master key is generated based on the first pairwise master key. The second pairwise master key may be further generated based on one or more characteristics of the first access point. For example, the second pairwise master key may be generated based on one or more of a media access control (MAC) address of the first access point, a basic service set identifier of the first access point, and/or one or more capabilities of the first access point.

In some aspects, one or more of the functions discussed above with respect to block 1515 may be performed by the processor 204. For example, a means for generating the second pairwise master key may include the processor 204.

In block 1520, the second pairwise master key is transmitted to the first access point. The second pairwise master key may be used by the first access point for secure association and/or secure communication between the first device and the first access point. For example, the first access point may encrypt or encode communications with the first device based on the second pairwise master key.

In some aspects, an additional key may be generated based on the second pairwise master key. This additional key may be generated by the first access point. For example, in some aspects, a pairwise transient key may be generated based on the second pairwise master key, and then the pairwise transient key may be used for communication with the first device by the first access point. For example, the first access point may encode and/or encrypt and/or decode and/or decrypt messages exchanged with the first device using the pairwise transient key.

In some aspects, one or more of the functions discussed above with respect to block 1520 may be performed by the processor 204 and/or the transmitter 210. For example, one or more of the processor 204 and/or the transmitter 210 may comprises a means for transmitting the second pairwise master key to the first access point. In some aspects, the first access point and the second device (e.g. WLC) may be collocated within the same physical device. They may be the same device in some aspects. In these aspects, the transmitting in block 1520 may not result in a physical transmission on a wireless network, but may instead result in the transmission of data between software and/or hardware components within one physically contained computing device.

In some aspects, a second authentication request for the first device (e.g. STA) may be received from a second access point. The second device (e.g. WLC) may generate a third pairwise master key (e.g. PMK-R1) for use by the second access point in communication with the first device. The third pairwise master key may be generated based on the first pairwise master key (e.g. PMK-R0). In some aspects, the third pairwise master key may be generated based on one or more characteristics of the second access point, such as a BSS identifier, and/or its MAC address or one or more capabilities of the second access point. The third pairwise master key may then be transmitted to the second access point. The third pairwise master key (e.g. PMK-R1) may then be used for communication with the first device by the third access point. Alternatively, a second pairwise transient key (PTK) may be generated based on the third pairwise master key. This generation may be performed by the second access point after it receives the third pairwise master key (PMK-R1) from the second device (e.g. WLC). The second pairwise transient key may then be used to encode/encrypt and/or decode/decrypt communications between the first device and the second access point.

Note that, in some aspects, the first pairwise master key may be specific for communication with the first device, which may be in some aspects, a wireless device such as STA 106a. If the second device supports communication with an additional device, such as a second wireless station or third device, the second device may generate an additional pairwise master key to facilitate communication with the third device.

Moreover, for each access point indicating a need to communicate with the third device (e.g. an additional wireless station), further pairwise master keys (in some aspects, a PMK-R1) may be generated for each of these access points based on the additional pairwise master key (e.g. a PMK-R0 in some aspects) (which may correspond to the third device). Thus, in some aspects, the second device (e.g. WLC) generates a separate “R0” pairwise master key for each individual device (e.g. station) with which it supports communication. Each access point that communicates with a particular individual device (e.g. STA) will receive a “R1” pairwise master key that is based on the “R0” pairwise master key for the particular individual device. Some or all of these keys may be based on the key shared (e.g. rMSK, MSK, or shared secret) with the particular individual device. In some aspects, a means for transmitting the second pairwise master key to the first access point may be one or more of the processor 204 and transmitter 210. For example, in some aspects, instructions in the memory 206 may configure the processor 204 to transmit the second pairwise master key to the first access point, via, for example, the transmitter 210.

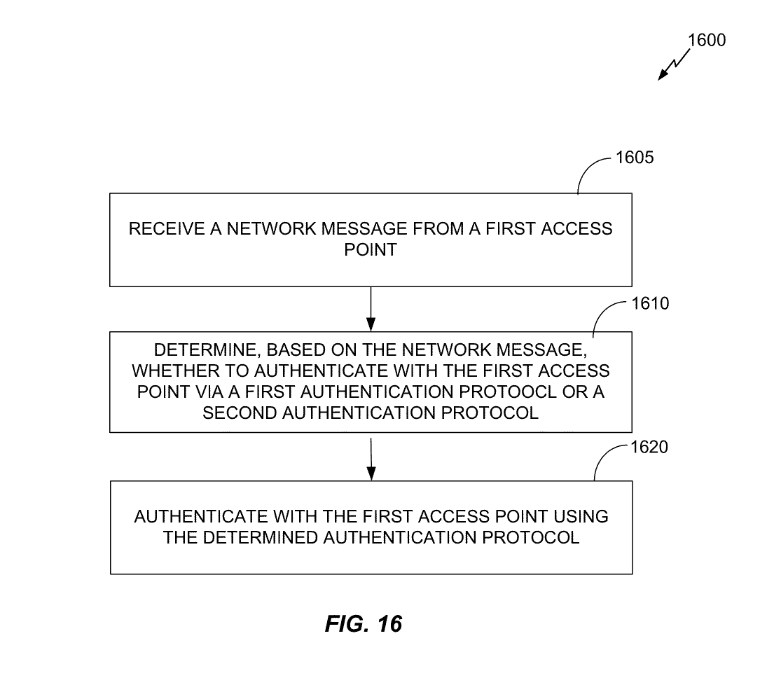

FIG. 16 is a flowchart of a method of authentication with over a network by a device. In some aspects, the process 1600 may be performed by the station 106a described above. In some aspects, the process 1600 may be performed by the device 202. For example, in some aspects, instructions in the memory 206 may configure the processor 204 to perform one or more of the functions discussed below with respect to process 1600. In some aspects, process 1600 may provide for interoperability between two different authentication protocols. For example, a first authentication protocol may provide some advantages over a second authentication protocol. The second authentication protocol may be widely deployed within a wireless network. Deploying the first authentication protocol widely throughout the network may be cost prohibitive and may require a substantial period of time before the deployment can be completed such that the first authentication protocol can be utilized in its entirely. While a second authentication protocol may provide some advantages over the first authentication protocol, deploying the second authentication protocol widely throughout a wireless network may be expensive and may not be accomplished for a substantial period of time in the future. Process 1600 described below may allow some implementations to leverage the benefits of the first authentication protocol, in that the first authentication protocol may already be widely deployed.

As discussed above, in some aspects, a station moving from a first access point to a second access point may stay within the same mobility domain, for example, if the first and second access points are part of the same mobility domain. When this occurs, it may be possible for the station to authenticate with the second access point without performing a full EAP authentication. Instead, if the two access points are within the same mobility domains, the station can authenticate using 802.11 Fast BSS transition authentication.

The process 1600 utilizes both the first and second authentication protocols to accomplish authentication of a wireless device with two separate access points. By utilizing the hybrid authentication approach via the two authentication protocols, fewer deployments of the second authentication protocol may be necessary to facilitate improved efficiency as compared to a deployment that utilizes the first authentication protocol exclusively to authenticate the first wireless device with the two access points.

In block 1605, a message is received from a first access point over a network by an authenticating device. The message may indicate one or more authentication protocols supported by the access point. For example, in some aspects, a capabilities list included in the message may indicate whether the first access point supports a first and/or a second authentication protocol. For example, the message may indicate whether the first access point supports IEEE 802.11 Fast BSS Transition (FT) authentication, and/or whether the first access point supports EAP (including EAP-RP) authentication. In some aspects, block 1605 may be performed by the receiver 212 and/or the processor 204.

In block 1610, a determination is made, by the authenticating device, whether to authenticate with the first access point via a first authentication protocol or a second authentication protocol based on the message received in block 1610. In some aspects, the authenticating device may prioritize authentication methods found to be supported by the access point. In some aspects, if a first authentication protocol is supported, the device may select the first authentication protocol. In some other implementations, the prioritization may be different, whereas in the same situation the second authentication protocol is supported.

In some aspects, the network message may indicate a mobility domain identifier, indicating which mobility domain the first access point is associated with. Some aspects of block 1610 also include authenticating with a second access point, and receiving a message from the second access point indicating a mobility domain identifier of the second access point. In some aspects, the authenticating device also authenticates with the second access point. The authenticating device may then move physical locations, and authenticate with the first access point. In some aspects, if the mobility domain of the first access point (which the authenticating device communicates with after previously authenticating with the second access point) is in a different mobility domain than the second access point, the device may determine to perform an EAP-RP authentication with the first access point.

In contrast, if the mobility domains of the two access points are the same, the authenticating device may utilize IEEE 802.11 Fast BSS Transition (FT) authentication to authenticate with the first access point.

In some aspects, the determination may be based on additional factors besides the network message. For example, in some aspects, if a period of time since a full EAP authentication has been performed by the device performing process 1600 exceeds a time threshold, then a full EAP authentication may be performed with the first access point, regardless of whether other authentication protocols are indicated to be supported by the first access point via the network message. In addition, if the authenticating device has never been authenticated with an access point then a full EAP authentication may be performed regardless of indications in the network message. In some aspects, one or more of the functions discussed above with respect to block 1610 may be performed by the processor 204.

In block 1620, the authenticating device authenticates with the first access point using the determined authentication protocol. Thus, in some aspects, block 1620 performs an IEEE 802.11 Fast BSS transition (FT) authentication message exchange with the first access point, for example, as described above with respect to FIG. 4. In some aspects, the authenticating device authenticates with the first access point using EAP (and/or EAP-RP) authentication, as described above for example in FIG. 3.

Using EAP-RP authentication, the authenticating device may derive a reauthentication master session key (rMSK). For example, the rMSK may be derived as: rMSK=KDF (K, S) where K=rRK and S=rMSK label|“\0”|SEQ \length. The rMSK label is an 8-bit ASCII string: “Re-authentication Master Session Key@ietf.org.” The length field refers to the length of the rMSK in octets. The rRK may be derived from a EMSK or DSRK. Please see RFC 5296 for more details.

The authenticating device may then generate a first pairwise master key based on the reauthentication master session key. In some aspects, the first pairwise master key may be generated in accordance with the generation of a PMK-R0 pairwise master key, as described in the IEEE 802.11 Fast BSS transition protocol standards. A second pairwise master key may then be generated based on the first pairwise master key. In some aspects, this second pairwise master key may be generated based on one or more properties of the first access point, such as a station address and/or BSS identifier of the first access point. The authenticating device may then communicate with the first access point using the second pairwise master key. For example, one or more messages sent to or received from the first access point may be encrypted and/or decrypted respectively using the second pairwise master key or using a key derived from the second pairwise master key, such as a PTK, discussed below.

In some aspects, the authenticating device may generate a third pairwise master key based on the first pairwise master key. This third pairwise master key may be generated in accordance with a PMK-R1 as described in the IEEE 802.11 Fast BSS transition protocol specifications. The third pairwise master key may also be generated in some aspects based on one or more properties of the second access point, such as a MAC station address of the second access point and/or a BSS identifier of the second access point. Communication with the second access point may be based on the third pairwise master key. For example, messages transmitted and/or received with the second access point may be based on the third pairwise master key, or on a key derived from the third pairwise master key, such as a PTK.

In some aspects, the authenticating device may determine whether perfect forward secrecy (PFS) is required for communication with the first access point. In some aspects, this determination is based on the network message received in block 1605. If it is determined that PFS is required, the authenticating device may perform a diffie-hellman key exchange with the first access point in response to the determining. In some aspects, the Diffie-Hellman key exchange is used to generate a pairwise transient key (PTK). In some aspects, the pairwise transcient key may be derived as: PTK=KDF(PMK, ANonce|SNonce|g^{AB}) where A is a STA's secret, B is an AP's secret (or vice versa) and g^{AB} is a result of a DH key exchange. Hence, in some aspects, before a STA and an AP derive a PTK, they may exchange g^{A} and g^{B} via a DH key exchange.

In some aspects, the PTK may then be used for communication with the first access point. For example, messages transmitted and or received to/from the first access point may be encrypted and/or decrypted using the PTK. In some aspects, a second PTK may be generated in a similar manner as described above for use in communication (encryption/decryption of messages) with the second access point.

In some aspects, one or more of the functions discussed above with respect to block 1620 may be performed by the processor 204, and, in some aspects, in conjunction with one or more of the receiver 212 and/or transmitter 210.

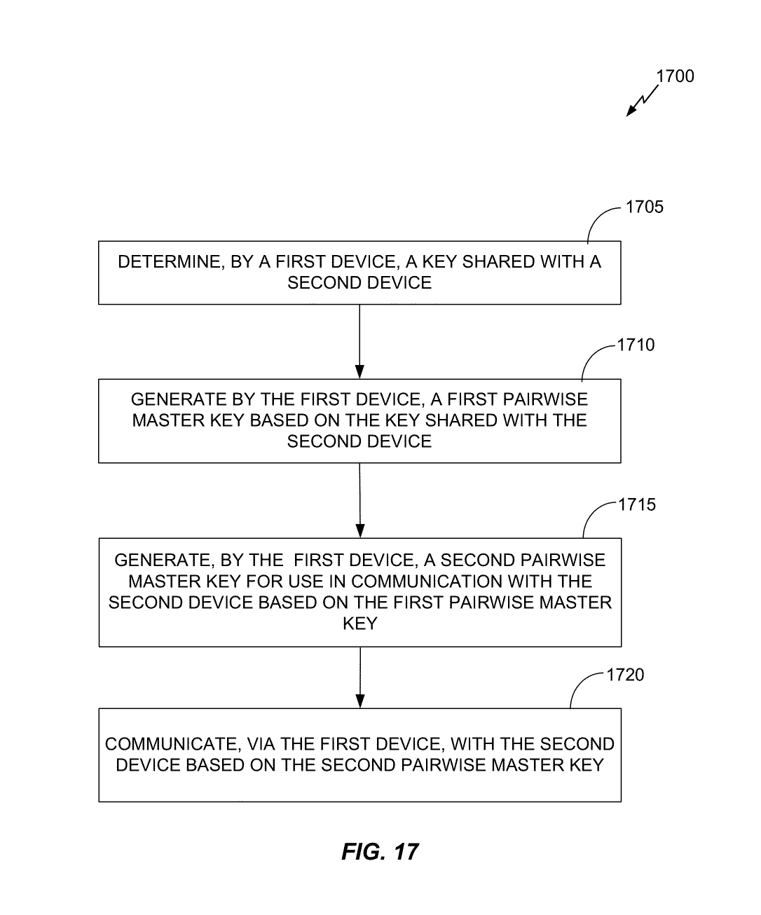

FIG. 17 is a flowchart of a method of authenticating a first device. In some aspects, the method 1700 may be performed by of the stations 106a described above, and/or the wireless device 202 of FIG. 2. For example, in some aspects, instructions in the memory 206 may configure the processor 204 to perform one or more of the functions discussed below with respect to process 1700. In some aspects, method 1700 is performed by an R0 key holder device as defined in the IEEE 802.11 fast transition key holder architecture. In some aspects, one or more of the first, second, and third devices discussed below with respect to method 1700 may or may not be wireless devices. In some aspects, method 1700 may be included in block 1620 of process 1600, discussed above with respect to FIG. 16. For example, in some aspects, the first and second pairwise master keys discussed above with respect to process 1600 may be the same keys as the first and second pairwise master keys discussed below with respect to method 1700. In these aspects, the second device discussed below with respect to process 1700 may be equivalent to the first access point discussed above with respect to FIG. 16 and process 1600.

In some aspects, method 1700 may provide for interoperability between two or even three different authentication protocols. For example, a first authentication protocol may provide some advantages over a second authentication protocol. The second authentication protocol may be widely deployed within a wireless network. Deploying the first authentication protocol widely throughout the network may be cost prohibitive and may require a substantial period of time before the deployment can be completed such that the first authentication protocol can be utilized in its entirely.

While the first authentication protocol may provide some advantages over the second authentication protocol, deploying the first authentication protocol widely throughout a wireless network may be expensive and may not be accomplished for a substantial period of time in the future. Method 1700 described below may allow some implementations to leverage the benefits of the first authentication protocol without deploying all of the components necessary for a full implementation of the first authentication protocol, and instead relying on the already deployed components of the second authentication protocol.

In block 1705, a shared key is determined. The key is shared with a second device. In some aspects, the shared key is a master session key, and may be determined via an extensible authentication protocol (EAP) exchange between the first device and the second device. In some aspects, the method 1700 is performed by the first device. In some aspects, the extensible authentication protocol exchange that determines the master session key is a shared key authentication that does not utilize perfect forward secrecy (PFS). In some aspects, the master session key may be received from an authentication server as part of the EAP authentication protocol, as shown in FIG. 3.

In some aspects, the shared key is a reauthentication master session key, which is determined, in part, by performing extensible authentication protocol reauthentication protocol (EAP-RP). In some aspects, the extensible authentication protocol—reauthentication protocol exchange is a shared key authentication that does not utilize perfect forward secrecy (PFS). In some aspects, the reauthentication master session key may be derived as: rMSK=KDF (K, S) where K=rRK and S=rMSK label|“\0”|SEQ \length. The rMSK label is an 8-bit ASCII string: “Re-authentication Master Session Key@ietf.org.” The length field refers to the length of the rMSK in octets. The rRK may be derived from an EMSK or DSRK (for example, as shown in FIG. 11).

In some aspects, the shared key is a shared secret. The shared secret may be determined in some aspects via a diffie hellman key exchange with the second device. In some aspects, one or more of the functions discussed above with respect to block 1705 may be performed by the processor 204. For example, a means for determining the shared key may include the processor 204.

In block 1710, a first pairwise master key is generated based on the key shared with the first device. In some aspects, the first pairwise master key is generated based on an intermediate key. In some aspects, the intermediate key may be generated based on a nonce derived from the first device. In some aspects, the intermediate key may be generated based on a nonce derived from the second device. In some aspects, the intermediate key may be generated based on the shared key. In some aspects, the intermediate key may be generated based on a combination of two or more of the nonce generated by the first device, nonce generated by the second device, and the shared key. In some aspects, the intermediate key is generated based on a hash based message authentication code (HMAC). For example, in some aspects, the intermediate key may be generated based on Equation 1 below:

Intermediate Key=HMAC-Hash(SNonce∥ANonce,IKM) (1)

Where:
SNonce is a nonce generated by the first device
ANonce is a nonce generated by the second device
IKM is:
   MSK if EAP full authentication is performed
   rMSK if shared key authentication is performed without perfect forward secrecy (PFS),
   rMSK|ss (i.e. concatenation of the rMSK and ss) in that order if using shared key authentication with perfect forward secrecy ss if public key authentication is used.
   Where:
      MSK is a master session key derived from an authentication server performing full EAP authentication rMSK is a reauthentication master session key derived by an authentication server and sent to the second device as a result of performing EAP-RP (as defined in RFC 6696) ss is a shared secret established as a result of Diffie-Hellman key exchange between first device and second device.

In some aspects, the result of the HMAC-Hash function may be truncated, for example, to 256 bits in some aspects. In some aspects, the intermediate key derived above may be used in substitution for an “XXKey” as described in the IEEE 802.11 Fast basic service set transition (FT) authentication.

An alternative implementation may derive the intermediate key as:

Intermediate key=KDF(PMK,“FILS PTK Derivation,”SPA∥AA∥SNonce∥ANonce) where:
where:
   KDF is a key derivation function using 384, 640, or 1024 bits PMK is from the PMKSA, either created from an initial FILS connection or from a cached PMKSA, when PMKSA caching is used. In some aspects, PMK is derived from rMSK SPA is an STA's MAC address and the AA is the AP's BSSID SNonce is the STA's nonce and ANonce is the AP's nonce

In some aspects, after the intermediate key is derived as described above, additional key derivation occurs as follows:
R0-Key-Data=KDF-384(intermediate key, “FT-R0”, SSIDlength∥SSID∥MDID∥R0KHlengh∥R0KH-ID∥S0KH-ID)
PMK-R0=L(R0-Key-Data, 0, 256)
PMK-R0Name-Salt=L(R0-Key-Data, 256-128)
PMKR0Name=Truncate-128(SHA-256(“FT-R0N”∥PMK-R0Name-Salt))
where “FT-R0N” is 0x46 0x54 0x2D 0x52 0x30 0x4E

### Where:

KDF-384 is a key derivation function using SHA-384.
MDID is a mobility domain identifier
R0KH-ID is a PMK-R0 Key Holder Identifier
S0KH-ID is a Supplicant Key holder Identifier

In some aspects, after the intermediate key is derived as described above, additional key derivation occurs as follows:
R0-Key-Data=KDF-384(intermediate key, “FT-R0”, SSIDlength∥SSID∥MDID∥R0KHlengh∥R0KH-ID∥S0KH-ID
PMK-R0=L(R0-Key-Data, 0, 256)
PMK-R0Name-Salt=L(R0-Key-Data, 256-128)
PMKR0Name=Truncate-128(SHA-256(“FT-R0N”∥PMK-R0Name-Salt))
where “FT-R0N” is 0x46 0x54 0x2D 0x52 0x30 0x4E

### Where:

KDF-384 is a key derivation function using SHA-384.
MDID is a mobility domain identifier
R0KH-ID is a PMK-R0 Key Holder Identifier
S0KH-ID is a Supplicant Key holder Identifier

In some aspects, the first pairwise master key is a PMK-R0, derived as described above. In some aspects, the first pairwise master key may be generated based on a second key shared with the first device. For example, in aspects where the first device derives a reauthentication master session key for use with the second device, a shared secret may also be shared with the second device. The shared secret may be generated via a diffie-hellman key exchange with the second device. In these aspects, the first pairwise master key may be generated based on both of these keys (i.e. the reauthentication master session key and the shared secret). In some aspects, the two keys are concatenated, and the first pairwise master key is generated based on the concatenation. For example, in some aspects, the shared secret follows the reauthentication master session key in the concatenation (i.e. rMSK|SS). In some aspects, one or more functions discussed above with respect to block 1710 may be performed by the processor 204. In some aspects, the processor 204 may comprise a means for concatenating as described above.

In block 1715, a second pairwise master key is generated for secure association and/or secure communication with the second device. The second pairwise master key is generated based on the first pairwise master key. The second pairwise master key may be further generated based on one or more characteristics of the second device. For example, the second pairwise master key may be generated based on a media access control (MAC) address of the second device, and/or one or more capabilities of the second device. If the second device is an access point, the second pairwise master key may be generated based on, for example, a basic service set identifier and/or a station address of the access point.

In block 1720, the second pairwise master key is used by the first device for secure association and/or secure communication between the first device and the second device. For example, the first device may encrypt or encode and/or decrypt or decode communications with the second device based on the second pairwise master key. In some aspects, one or more of the functions discussed above with respect to block 1715 may be performed by the processor 204. For example, a means for generating the second pairwise master key may include the processor 204.

In block 1720, the first device communicates with the second device based on the second pairwise master key. For example, the first device may encode communications with the second device using the second pairwise master key. Alternatively, the first device may derive an additional key from the second pairwise master key. This additional key may be used to encode and/or decode communications with the first device. For example, the first device may derive a pairwise transient key in some aspects based on the second pairwise master key. The pairwise master key may then be used to encrypt and/or decrypt communications with the second device.

Some aspects of process 1700 also include generation, by the first device, of a third pairwise master key for use in communication with a third device, based on the first pairwise master key. In some aspects, this third pairwise master key is generated based on one or more properties of the third device. For example, the third pairwise master key may be generated based on one or more of a station address of the third device, one or more properties or capabilities of the third device, and/or a basic service set identifier of the third device (if the third device is an access point). These aspects of process 1700 may also include communicating with the third device based on the third pairwise master key. In some aspects, the first device may derive a pairwise transient key based on the third pairwise master key, and utilize the pairwise transient key to encrypt and/or decrypt communications with the third device.

In some aspects, one or more of the functions discussed above with respect to block 1720 may be performed by the processor 204 and/or the transmitter 210. For example, one or more of the processor 204 and/or the transmitter 210 may comprises a means for communicating with the second device based on the second pairwise master key.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable storage medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method of authenticating a station, comprising
performing, by a wireless local area network (LAN) controller, extensible authentication protocol reauthentication protocol with the station to derive a reauthentication master session key;
generating, by the wireless LAN controller, a first pairwise master key based on the reauthentication master session key;
generating, by the wireless LAN controller, a second pairwise master key for a first access point based on the first pairwise master key; and
transmitting, by the wireless LAN controller, the second pairwise master key to the first access point.

2. The method of claim 1, further comprising securely associating or securely communicating with the station based on the second pairwise master key.

3. The method of claim 1, wherein the first access point includes the wireless LAN controller.

4. The method of claim 1, further comprising:
performing a diffie hellman key exchange with the station to derive a shared secret; and
generating the first pairwise master key further based on the shared secret.

5. The method of claim 4, wherein the generating of the first pairwise master key is based on a concatenation of the reauthentication master session key and the shared secret.

6. The method of claim 1, further comprising:
generating an intermediate key based on:
a nonce generated by the station,
a second nonce generated by the wireless LAN controller, and
the reauthentication master session key; and
generating the first pairwise master key based on the intermediate key.

7. The method of claim 1, further comprising:
generating, by the wireless LAN controller, a third pairwise master key for a second access point based on the first pairwise master key, the third pairwise master key for use in communication between the second access point and the station; and
transmitting the third pairwise master key to the second access point.

8. An apparatus for authenticating a station, comprising
a processor, configured to:
performing extensible authentication protocol reauthentication protocol with the station to determine a reauthentication master session key;
generate a first pairwise master key based on the reauthentication master session key;
generate a second pairwise master key for a first access point based on the first pairwise master key; and
a transmitter configured to transmit the second pairwise master key to the first access point.

9. The apparatus of claim 8, wherein the processor is further configured to securely associate or securely communicate with the station based on the second pairwise master key.

10. The apparatus of claim 8, further comprising the first access point.

11. The apparatus of claim 8, wherein the processor is further configured to perform a diffie hellman key exchange with the station to determine a shared secret, and generate the first pairwise master key further based on the shared secret.

12. The apparatus of claim 11, wherein the processor is further configured to generate the first pairwise master key based on a concatenation of the reauthentication master session key and the shared secret.

13. The apparatus of claim 8, wherein the processor is further configured to:
generate an intermediate key based on:
a nonce generated by the station,
a nonce generated by the apparatus,
and the reauthentication master session key, and
generate the first pairwise master key based on the intermediate key.

14. The apparatus of claim 8, wherein the processor is further configured to:
generate a third pairwise master key for a second access point based on the first pairwise master key, the third pairwise master key for use in communication between the second access point and the station, and wherein the transmitter is further configured to transmit the third pairwise master key to the second access point.

15. A computer readable storage medium comprising instructions that when executed cause a processor to perform a method of authenticating a station, the method comprising
performing, by a wireless local area network (LAN) controller, extensible authentication protocol reauthentication protocol with the station to determine a reauthentication master session key;
generating, by the wireless LAN controller, a first pairwise master key based on the reauthentication master session key;
generating, by the wireless LAN controller, a second pairwise master key for a first access point based on the first pairwise master key; and
transmitting, by the wireless LAN controller, the second pairwise master key to the first access point.

16. A method of authenticating a station, comprising
performing, by the station, extensible authentication protocol reauthentication protocol with an access point to determine a reauthentication master session key;
generating, by the station, a first pairwise master key based on the reauthentication master session key;
generating, by the station, a second pairwise master key based on the first pairwise master key; and
communicating, by the station, with the access point based on the second pairwise master key.

17. The method of claim 16, further comprising performing a diffie hellman key exchange with the access point to determine a shared secret, and generating the first pairwise master key further based on the shared secret.

18. The method of claim 17, wherein the generating of the first pairwise master key is based on a concatenation of the reauthentication master session key and the shared secret.

19. The method of claim 16, further comprising:
generating an intermediate key based on:
a nonce generated by the station,
a second nonce provided by the access point, and
the reauthentication master session key; and
generating the first pairwise master key based on the intermediate key.

20. An apparatus for authenticating a station, comprising
a processor configured to:
perform extensible authentication protocol reauthentication protocol with an access point to determine a reauthentication master session key,
generate a first pairwise master key based on the reauthentication master session key,
generate a second pairwise master key based on the first pairwise master key, and
communicate with the access point based on the second pairwise master key.

21. The apparatus of claim 20, wherein the processor is further configured to perform a diffie hellman key exchange with the access point to determine a shared secret, and wherein the generating of the first pairwise master key is further based on the shared secret.

22. The apparatus of claim 21, wherein the generating of the first pairwise master key is based on a concatenation of the reauthentication master session key and the shared secret.

23. The apparatus of claim 20, wherein the processor is further configured to:
generate an intermediate key based on:
a nonce generated by the station,
a second nonce provided by the access point, and
the reauthentication master session key, and
generate the first pairwise master key based on the intermediate key.
